(19) United States
(12) Patent Application Publication
(10) Pub. No.: US 2024/0207800 A1
(43) Pub. Date: Jun. 27, 2024

(54) MIXER VEHICLE WITH TWIN SCREW MIXER

(71) Applicant: Oshkosh Corporation, Oshkosh, WI (US)

(72) Inventors: Erik S. Ellifson, Oshkosh, WI (US); Bryan Datema, Rochester, MN (US); Robert Varao, Oshkosh, WI (US); Clint Glunz, Rochester, MN (US)

(73) Assignee: Oshkosh Corporation, Oshkosh, WI (US)

(21) Appl. No.: 18/392,044

(22) Filed: Dec. 21, 2023

Related U.S. Application Data
(60) Provisional application No. 63/435,102, filed on Dec. 23, 2022.

(51) Int. Cl. B01F 27/723; B01F 27/1143; B01F 33/502; B01F 35/221

(52) U.S. Cl. CPC B01F 27/723; B01F 27/1143; B01F 33/5021; B01F 35/2213; B01F 2101/28

(57) ABSTRACT

A mixer vehicle comprises a chassis and mixer drum coupled with the chassis. The mixer drum includes a first cylindrical inner volume and a second cylindrical inner volume. The first cylindrical inner volume and the second cylindrical inner volume are fluidly coupled with each other at passageways positioned at both ends of the mixer drum. The mixer drum further comprises a first mixer screw positioned within the first cylindrical inner volume and a second mixer screw positioned within the second cylindrical inner volume. The first mixer screw and the second mixer screw are configured to be driven to rotate to drive a slurry material between the first cylindrical inner volume and the second cylindrical inner volume to mix the slurry material.

### CROSS-REFERENCE TO RELATED APPLICATION

This application claims the benefit and priority to U.S. Provisional Application No. 63/435,102, filed Dec. 23, 2022, the contents of which are incorporated herein by reference in its entirety for all purposes.

### BACKGROUND

The present disclosure relates to concrete mixing vehicles. More particularly, the present disclosure relates to mixing systems for concrete mixing vehicles.

### SUMMARY

One embodiment relates to a mixer vehicle that includes a chassis and mixer drum coupled with the chassis. The mixer drum includes a first cylindrical inner volume and a second cylindrical inner volume. The first cylindrical inner volume and the second cylindrical inner volume are fluidly coupled with each other at passageways positioned at both ends of the mixer drum. The mixer drum further comprises a first mixer screw positioned within the first cylindrical inner volume and a second mixer screw positioned within the second cylindrical inner volume. The first mixer screw and the second mixer screw are configured to be driven to rotate to drive a slurry material between the first cylindrical inner volume and the second cylindrical inner volume to mix the slurry material.

Another embodiment relates to a first mixer screw and a second mixer screw in which each include a shaft and a plurality of helical surfaces or fins extending radially outwards from the shaft.

Another embodiment relates to a first mixer screw and a second mixer screw that are configured to operate to drive the slurry material towards a rear of the mixer drum for a rear discharge of the slurry material from the mixer drum.

Another embodiment relates to a first mixer screw and a second mixer screw that are configured to operate to drive the slurry material towards a front of the mixer drum for a front discharge of the slurry material from the mixer drum.

Another embodiment relates to a mixer vehicle a having a discharge system. The discharge system includes a first discharge auger positioned at a first end of the mixer drum.

Another embodiment relates to a mixer vehicle including a discharge system that further includes a second discharge auger positioned at a second end of the mixer drum. The first discharge auger and the second discharge auger extend into the mixer drum and are configured to discharge the slurry material from the mixer drum to a first chute assembly positioned at a forward end of the mixer vehicle or a second chute assembly positioned at a rearward end of the mixer vehicle.

Another embodiment relates to a discharge system with a mount coupled to a chassis and a mixer drum. A second chute assembly is positioned at the rearwards end of the mixer vehicle, and a conveyor belt that is driven by an electric motor. A slurry may be discharged via the second chute assembly onto a conveyor belt.

Another embodiment relates to a mixer vehicle with a side door outlet and a side door removably coupled to the mixer drum, such that the slurry material is discharged from the mixer drum through the side door outlet when the side door is removed from the mixer drum.

Another embodiment relates to a side door outlet, in which the side door is configured to receive a hose or a pump such that the slurry material is discharged via the hose or the pump without the side door being removed from the mixer drum.

Another embodiment relates to a mixer vehicle with a mixer drum that is configured to rotate relative to a first mixer screw and a second mixer screw.

Another embodiment relates to a mixer vehicle with a first mixer screw and a second mixer screw that are made up of a first torsionally loaded mixer reel and a second torsionally loaded mixer reel. The first torsionally loaded mixer reel and a second torsionally loaded mixer reel each include a first member and a second member, at least one elongated member extending between the first member and the second member, and at least one loaded member extending between the first member and the second member.

Still another embodiment relates to a mixer system for a mixer vehicle. The mixer system includes a first mixer screw and a second mixer screw. The first mixer screw and the second mixer screw each include a shaft and a plurality of helical surfaces or fins extending radially outwards from the shaft, and a mixer driver coupled to the first mixer screw and the second mixer screw. The mixer driver is configured to rotate the first mixer screw and the second mixer screw to mix a slurry material.

Another embodiment relates to a controller in communication with the mixer driver, the controller being configured to: measure a consistency of the slurry material based on a pressure or an amperage draw of the mixer driver, determine a desired consistency of the slurry material, and adjust a speed of rotation of the first mixer screw and the second mixer screw to obtain the desired consistency of the slurry material.

Another embodiment relates to a controller that is configured to: measure the amperage draw of the mixer driver, determine a slump of the mixer driver based on the amperage draw of the mixer driver, adjust operation of the mixer driver based on the slump, and present a notification of an additive being introduced into the mixer drum.

Another embodiment relates to a controller that is configured to: measure the pressure of the mixer driver, determine a slump of the mixer driver based on the pressure of the mixer driver, adjust operation of the mixer driver based on the slump, and present a notification of an additive being introduced into the mixer drum.

Another embodiment relates to a mixer system that includes one or more batteries configured to provide electrical power to the mixer driver.

Still another embodiment relates to a method of manufacturing a mixer vehicle that includes providing a chassis with a frame member extending substantially horizontally, the chassis having a front end and a rear end. The method also includes coupling a mixer drum to the chassis, wherein the mixer drum defines a first cylindrical inner volume and a second cylindrical inner volume. The method further includes positioning a first mixer screw within the first cylindrical inner volume and positioning a second mixer screw within the second cylindrical inner volume. The method further includes driving the first mixer screw and the second mixer screw to rotate and mix a slurry material between the first cylindrical inner volume and the second cylindrical inner volume.

Another embodiment relates to a method for manufacturing a mixer vehicle, including measuring a consistency of the slurry material and operating a first mixer screw and a second mixer screw to adjust the consistency of the slurry material.

Another embodiment relates to powering a first mixer screw and a second mixer screw using a battery.

Another embodiment relates to a method that includes positioning a first discharge auger at a first end of the mixer drum, positioning a second discharge auger at a second end of the mixer drum; and discharging, via the first discharge auger and the second discharge auger, the slurry material from the mixer drum.

### BRIEF DESCRIPTION OF THE DRAWINGS

FIG. 1 is a perspective view of a mixer vehicle with a twin screw mixer, according to some embodiments.

FIG. 2 is a side view of the mixer vehicle of FIG. 1, according to some embodiments.

FIG. 3 is a perspective view of the mixer vehicle of FIG. 1, illustrating the twin screw mixer, according to some embodiments.

FIG. 4 is a perspective view of the twin screw mixer of FIG. 1, according to some embodiments.

FIG. 5 is a diagram of the twin screw mixer of FIG. 1 operating in a rear discharge mode, according to some embodiments.

FIG. 6 is a diagram of the twin screw mixer of FIG. 1 operating in a front discharge mode, according to some embodiments.

FIG. 7 is a diagram of the twin screw mixer of FIG. 1 operating in a mixing mode, according to some embodiments.

FIG. 8 is a diagram of a drum mixing system, according to some embodiments.

FIG. 9 is a diagram of the twin screw mixing system of FIG. 1, according to some embodiments.

FIG. 10 is a perspective view of the twin screw mixing system of FIG. 1, according to some embodiments.

FIG. 11 is another perspective view of the twin screw mixing system of FIG. 1, according to some embodiments.

FIG. 12 is another perspective view of the twin screw mixing system of FIG. 1, according to some embodiments.

FIG. 13 is diagram of the twin screw mixing system of FIG. 1 including mixing drivers, according to some embodiments.

FIG. 14 is a diagram of the twin screw mixing system of FIG. 1 including discharge drivers, according to some embodiments.

FIG. 15 is a block diagram of a driveline for the mixer vehicle of FIG. 1, according to some embodiments.

FIG. 16 is a perspective view of a chassis arrangement of the mixer vehicle of FIG. 1, according to some embodiments.

FIG. 17 is a sectional view of the twin screw mixer of FIG. 1, according to some embodiments.

FIG. 18 is a side view of a screw for the twin screw mixer of FIG. 1, according to some embodiments.

FIG. 19 is a side view of another screw for the twin screw mixer of FIG. 1, according to some embodiments.

FIG. 20 is a diagram of another screw and a washout system for the twin screw mixer of FIG. 1, according to some embodiments.

FIG. 21 is a sectional view of a portion of the twin screw mixer of FIG. 1 illustrating engagement between an end of a screw and an inner surface of the mixer drum, according to some embodiments.

FIG. 22 is a view of the end of the screw of FIG. 21, according to some embodiments.

FIG. 23 is a side view of a screw for the twin screw mixer of FIG. 1 including different flight spacing, according to some embodiments.

FIG. 24 is a side view of a screw for the twin screw mixer of FIG. 1 including a stepped central shaft, according to some embodiments.

FIG. 25 is a top view of the twin screw mixer of FIG. 1 including two separate chambers, according to some embodiments.

FIG. 26 is a top view of the twin screw mixer of FIG. 1 including three separate chambers, according to some embodiments.

FIG. 27 is a top view of the twin screw mixer of FIG. 1 including three chambers that are fluidly coupled with each other, according to some embodiments.

FIG. 28 is a top view of the twin screw mixer of FIG. 1 including a chain drive for the screws, according to some embodiments.

FIG. 29 is a top view of the twin screw mixer of FIG. 1 including another chain drive for the screws, according to some embodiments.

FIG. 30 is a top view of the twin screw mixer of FIG. 1 including two screws spaced apart to form a gap, according to some embodiments.

FIG. 31 is a side view of the configuration of the twin screw mixer of FIG. 30, according to some embodiments.

FIG. 32 is a top view of the twin screw mixer of FIG. 1, including two top doors for accessing inner volumes of the mixer drum, according to some embodiments.

FIG. 33 is a top view of the twin screw mixer of FIG. 1 including a top door for accessing both inner volumes of the mixer drum, according to some embodiments.

FIG. 34 is a side view of the twin screw mixer of FIG. 32 or FIG. 33 including a cover for the top doors, according to some embodiments.

FIG. 35 is a block diagram of a control system for the mixer vehicle of FIG. 1, according to some embodiments.

FIG. 36 is a side view of the twin screw mixer of FIG. 1 including a discharge conveyor positioned below the mixer drum, according to some embodiments.

FIG. 37 is a side view of the twin screw mixer of FIG. 1 including a trap door in the mixer drum for discharging slurry material from the mixer drum using gravity, according to some embodiments.

FIG. 38 is a perspective view of the twin screw mixer of FIG. 1 including a side outlet, according to some embodiments.

FIG. 39 is a perspective view of the twin screw mixer of FIG. 1 including externally mounted nozzles, according to some embodiments.

FIG. 40 is a side view of the mixer vehicle of FIG. 1 including a fluid reservoir and an additive reservoir positioned above the mixer drum, according to some embodiments.

FIG. 41 is a side view of the mixer vehicle of FIG. 1 including a fluid reservoir and an additive reservoir positioned beneath the mixer drum, according to some embodiments.

FIG. 42 is a side view of the mixer vehicle of FIG. 1 with the mixer drum oriented at an angle, according to some embodiments.

FIG. 43 is a side view of the mixer vehicle of FIG. 1 with the mixer vehicle hingedly coupled with the chassis and pivotable by an actuator, according to some embodiments.

FIG. 44 is a sectional view of a mixer drum for the mixer vehicle of FIG. 1 where the screw engages an inner surface of the mixer drum, includes removably coupled fins, and includes an opening in the fins, according to some embodiments.

FIG. 45 is a perspective view of a torsionally loaded mixer screw for the mixer vehicle of FIG. 1, according to some embodiments.

FIG. 46 is a sectional view of a mixer drum for the mixer vehicle of FIG. 1 where the mixer drum is driven to rotate relative to the screw, according to some embodiments.

FIG. 47 is a sectional view of a mixer drum for the mixer vehicle of FIG. 1 where mixer drum includes mixing geometry and is configured to be driven to rotate relative to the screw, according to some embodiments.

FIG. 48 is a diagram of the mixer drum of the mixer vehicle of FIG. 1 with the twin screws oriented in parallel, according to some embodiments.

FIG. 49 is a diagram of the mixer drum of the mixer vehicle of FIG. 1 with the twin screws oriented in a non-parallel configuration, according to some embodiments.

FIG. 50 is a side view of the mixer vehicle of FIG. 1 including a gangway on top of the mixer drum and a ladder to access the gangway, according to some embodiments.

FIG. 51 is a diagram of a mixer drum for the mixer vehicle of FIG. 1 including an upper and lower passageway, according to some embodiments.

FIG. 52 is a side view of the mixer drum of FIG. 51, according to some embodiments.

FIG. 53 is a diagram illustrating the mixer drum being assembled with multiple sections, and the screw also being assembled with multiple sections, according to some embodiments.

FIG. 54 is a side view of the mixer vehicle of FIG. 1 having batteries for powering electrical components of the mixer vehicle, according to some embodiments.

FIG. 55 is a side view of a front discharge system of the mixer vehicle of FIG. 1, according to some embodiments.

FIG. 56 is a side view of a rear discharge system of the mixer vehicle of FIG. 1, according to some embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a concrete mixer vehicle includes a twin screw mixer having a mixer drum and two mixer screws. The mixer drum may be mounted or oriented in a direction substantially parallel with a chassis of the mixer vehicle and has a reduced height and center of gravity relative to single-drum pitched mixer vehicles. The mixer screws may be positioned within two chambers of the mixer drum that are fluidly coupled with each other through passages. In some embodiments, the mixer screws rotate (e.g., independently) to mix a slurry material within the mixer vehicle. The mixer screws can also operate to bias the slurry material to a front of the mixer drum or a rear of the mixer drum for either front or rear discharge from the mixer vehicle.

The twin screw mixer advantageously can be used for low clearance batch plants since it has reduced height. The twin screw mixer can also provide front and rear discharge of the slurry material which may be required for various jobsites. The twin screw mixer also provides improved mobility of the slurry material for high mobility demands and can accommodate air transportable configurations. The twin screw mixer also facilitates a lower center of gravity while providing improved mixing of the slurry material. In some embodiments, the twin screw mixer also has an increased capacity relative to single drum mixer systems. Further, the twin screw mixer may share components or parts with other twin screw mixers having different sizes. In some embodiments, the twin screw mixer includes dual discharge modes, and facilitates reduced chassis lean (e.g., when cornering due to the lowered center of gravity).

### Mixer Vehicle

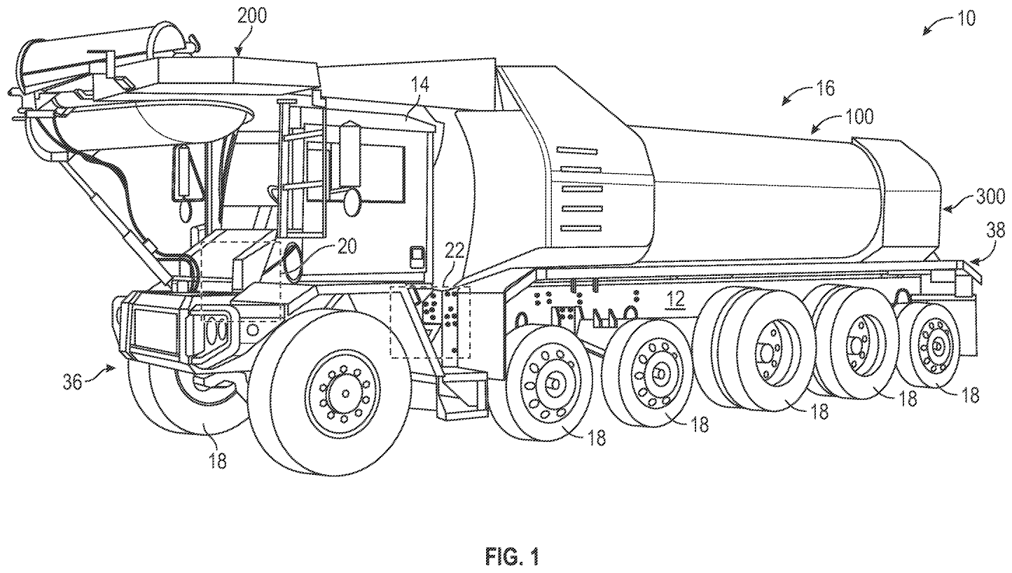

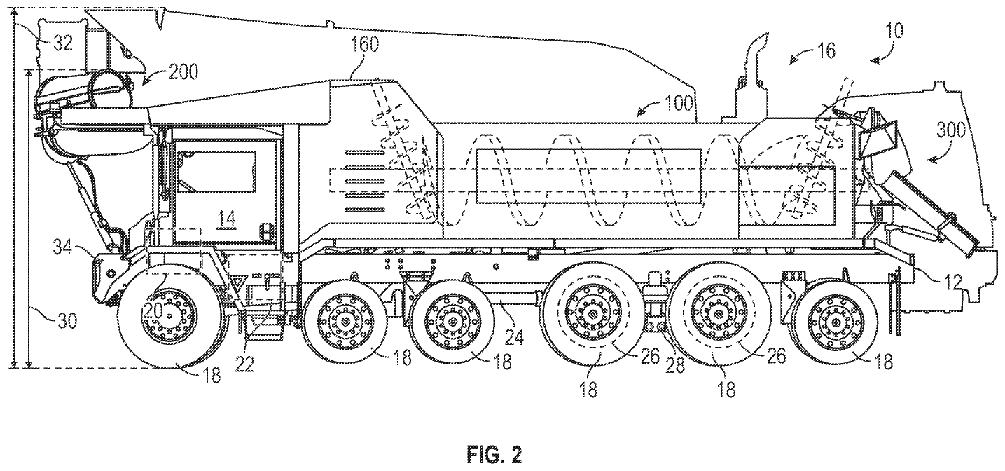

Referring to FIGS. 1 and 2, a vehicle, a concrete mixer, etc., shown as mixer vehicle 10 includes a chassis 12 (e.g., a frame), a twin screw mixer system 100, a cab 14 (e.g., a cabin, a housing, etc.), tractive elements 18, a prime mover 20, a transmission 22, a front discharge system 200, and a rear discharge system 300. In some embodiments, the prime mover 20 is an engine (e.g., an internal combustion engine, a diesel engine, etc.) that is configured to consume a fuel and operate to drive the tractive elements 18 (e.g., wheels) to transport the mixer vehicle 10. In some embodiments, the prime mover 20 is an electric motor that is configured to consume or use electrical energy and operate to drive the tractive elements 18 for transportation. In some embodiments, the prime mover 20 is configured to drive the tractive elements 18 through a transmission 22 (e.g., a gear box), one or more drive shafts 24, and one or more differentials 26. The prime mover 20, the transmission 22, the drive shafts 24, and the differentials 26 may define a driveline through which power is transferred from the prime mover 20 to the tractive elements 18. The tractive elements 18 may be rotatably coupled with the chassis 12 (e.g., a frame, a pair of rails, etc.). In some embodiments, the cab 14 includes doors, seating arrangements, a steering wheel, a gear selector, etc., for operating the mixer vehicle 10. In some embodiments, the chassis 12 is a torsionally rigid chassis.

In some embodiments, the front discharge system 200 (e.g., an assembly) extends frontwards or towards a front of the mixer vehicle 10 over the cab 14. In some embodiments, the front discharge system 200 extends forwards past a front bumper 34 that is positioned at a bottom of the cab 14. In some embodiments, the front discharge system 200 is configured to receive a discharge of concrete, cement, asphalt, gravel, etc., or any slurry material from the twin screw mixer system 100 and guide the slurry material to discharge to a work space or ground surface that is accessible by the front discharge system 200 (e.g., in front of the mixer vehicle 10, proximate a front end 36 of the mixer vehicle 10, on a left or right side of the mixer vehicle 10 at a forwards position along the mixer vehicle 10, etc.). In some embodiments, the rear discharge system 300 is positioned at a rear end 38 of the mixer vehicle 10 (e.g., at a back end, at an end opposite the front discharge system 200, etc.) and is configured to receive the slurry material from the twin screw mixer system 100 and discharge or guide the slurry material to a worksite or jobsite that is rearwards of the mixer vehicle 10 (e.g., behind the mixer vehicle 10, proximate the rear end 38 of the mixer vehicle 10, on a left or right side of the mixer vehicle 10 at a rearwards position along the mixer vehicle 10, etc.).

Referring particularly to FIG. 2, the twin screw mixer system 100 facilitates reduced height of the mixer vehicle 10 relative to a mixer vehicle that uses a single drum (e.g., at an incline). For example, the mixer vehicle 10 may have an overall height 30 that is less than a height 32 of a mixer vehicle that uses a single drum. Advantageously, the reduced height of the mixer vehicle 10 facilitates a lowered center of gravity, improved overhead clearance during driving, and improved ride stability while transporting the mixer vehicle 10.

### Twin Screw Mixer System

### Screw Configuration

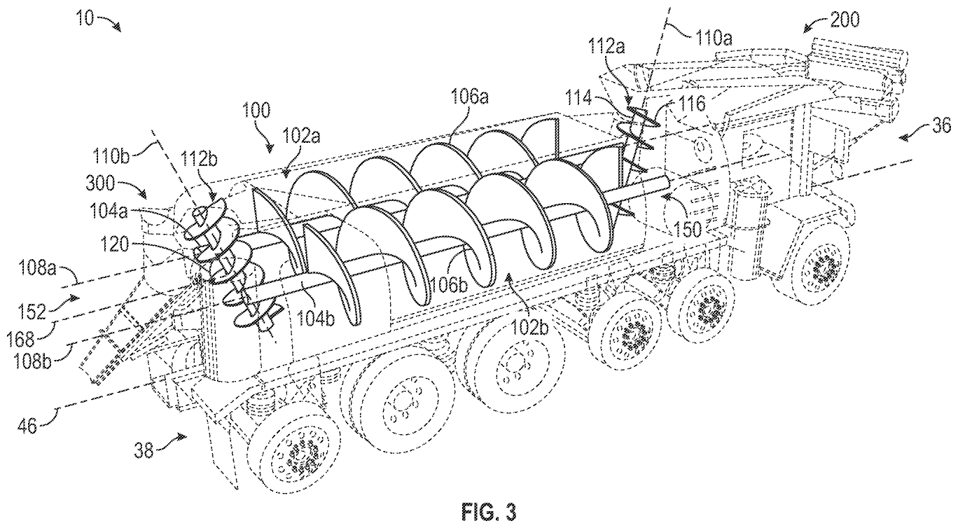

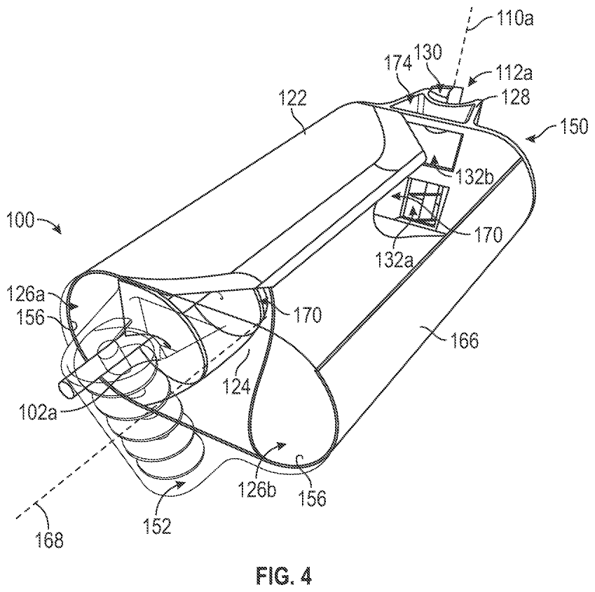

Referring to FIGS. 3 and 4, the twin screw mixer system 100 includes a container, a mixer volume, a drum, a two-chambered drum, an enclosed space, receptacle, a vessel, a repository, a canister, etc., shown as mixer drum 122 includes a sidewall 166, and a divider 124. The sidewall 166 and the divider 124 may have the form of two cylinders or capsules that are joined along two lengthwise edges or peripheries. In some embodiments, the sidewall 166 and the divider 124 define a pair of inner surfaces 156 that have a circumferential or circular shape. In some embodiments, the inner surface 156 are cylindrical shaped inner surfaces that extend a length of a longitudinal axis 168 of the twin screw mixer system 100. In some embodiments, the sidewalls 166 and the divider 124 (e.g., a dividing wall, an arcuate wall, etc.) define a first inner volume 126a and a second inner volume 126b. In some embodiments, the inner surfaces 156 define peripheries of the first inner volume 126a and the second inner volume 126b.

The twin screw mixer system 100 also includes a first screw 102a and a second screw 102b (e.g., augers, mixing screws, helical drive members integrally formed or mounted on a driveshaft). The first screw 102a is positioned within the first inner volume 126a and the second screw 102b is positioned within the second inner volume 126b. In some embodiments, the first inner volume 126a and the second inner volume 126b collectively or aggregately form a storage volume for the slurry material. The slurry material can be stored in the storage volume during transportation and discharged from the storage volume during discharge, dispensing, or pouring of the slurry material. In some embodiments, the first inner volume 126a and the second inner volume 126b are fluidly coupled with each other through openings 170 (e.g., windows, apertures, channels, etc.) at opposite longitudinal ends of the sidewalls 166. The openings 170 are configured to allow the exchange of slurry material between the first inner volume 126a and the second inner volume 126b for mixing of the slurry material. In some embodiments, the openings 170 are formed by a shape of the divider 124. In some embodiments, the first screw 102a and the second screw 102b are removable and replaceable with screws having different configurations in order to achieve desired mixing or mixture properties, or to service the first screw 102a and the second screw 102b.

The first screw 102a and the second screw 102b extend along and are configured to be driven about corresponding axes 108a and 108b. In some embodiments, the first screws 102a and the second screw 102b are substantially parallel with each other. In some embodiments, the axes 108a and 108b are substantially parallel with a longitudinal axis 46 of the mixer vehicle 10 (e.g., the screw 102a and the screw 102b are oriented in a flat or horizontal direction). In some embodiments, the longitudinal axis 168 of the twin screw mixer system 100 is substantially parallel with the longitudinal axis 46 of the mixer vehicle 10. In some embodiments, the first screw 102a and the second screw 102b each include a corresponding shaft 104 and helical surfaces 106 (e.g., fins). In particular, the first screw 102a includes the shaft 104a and the helical surfaces 106a, and the second screw 102b includes the shaft 104b and the helical surfaces 106b. In some embodiments, the helical surfaces 106a and 106b are right-handedly oriented about the corresponding axes 108a and 108b, assuming a positive direction along the axes 108 is towards the front end 36 of the mixer vehicle 10. In some embodiments, the helical surfaces 106 are manufactured from a composite material that flexes to allow back flow or mixing of the slurry material in the mixer drum 122. In some embodiments, the helical surfaces 106 define a ribbon drive, similar to a snow blower, and include rubber or flexible ends for engaging the slurry material along a wall or surface of the mixer drum 122.

In some embodiments, the screws 102 and the mixer drum 122 have a scalable length in order to accommodate different vehicles or chassis having different lengths or to result in a mixer vehicle having a desired capacity. In some embodiments, the mixer drum 122 has a capacity that is greater than other mixer vehicles that use a single chamber drum at an angle. In some embodiments, the mixer drum 122 and/or the chassis 12 are provided as a unibody assembly which reduces a need for double frames and reduces cross-members and sectional size of the chassis 12 and mixer drum 122. The twin-screw configuration of the twin screw mixer system 100 facilitates improved balance (e.g., having a reduced center of gravity) while mixing and loading slurry material.

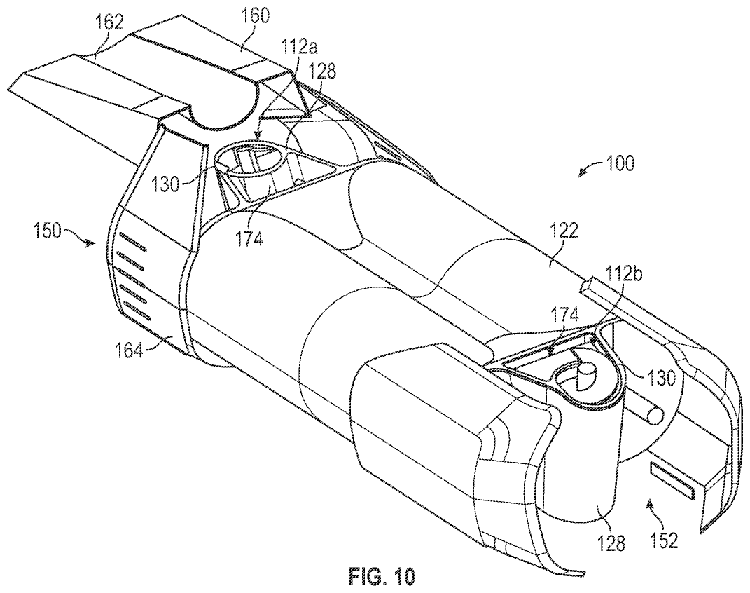

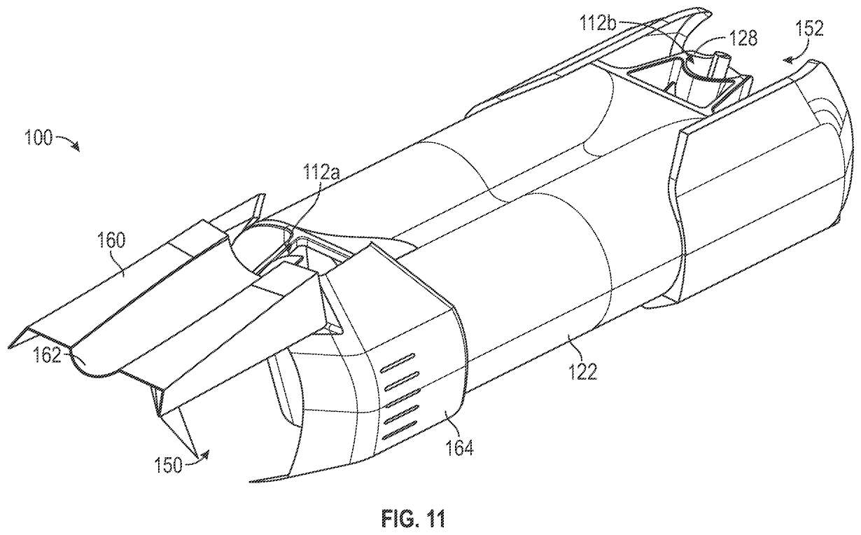

Referring to FIGS. 3-4 and 10-12, the twin screw mixer system 100 includes a first discharge screw 112a and a second discharge screw 112b (e.g., augers). In some embodiments, the first discharge screw 112a is positioned at a first longitudinal end 150 of the twin screw mixer system 100 (e.g., proximate the front end 36 of the mixer vehicle 10 and the front discharge system 200). In some embodiments, the second discharge screw 112b is positioned at a second longitudinal end 152 of the twin screw mixer system 100 (e.g., proximate the rear end 38 of the mixer vehicle 10 and the rear discharge system 300). In some embodiments, the first discharge screw 112a is positioned within an inner volume 130 of a sidewall 128 at the first longitudinal end 150 of the mixer drum 122. In some embodiments, the inner volume 130 of the sidewall 128 is configured to fluidly couple with the first inner volume 126a and the second inner volume 126b at the first longitudinal end 150 of the mixer drum 122 through a window 132a (e.g., an opening, an aperture, etc.). The second discharge screw 112b is similarly positioned at the second longitudinal end 152 within a sidewall 128 at the second longitudinal end 152 (e.g., proximate the rear end 38 of the mixer vehicle 10, proximate the rear discharge system 300) of the mixer drum 122. The second discharge screw 112b is positioned within an inner volume 130 of the sidewall 128 at the second longitudinal end 152. In some embodiments, the inner volumes 130 are both configured to fluidly couple with the first inner volume 126a and the second inner volume 126b through windows 132a positioned at both opposite ends of the mixer drum 122.

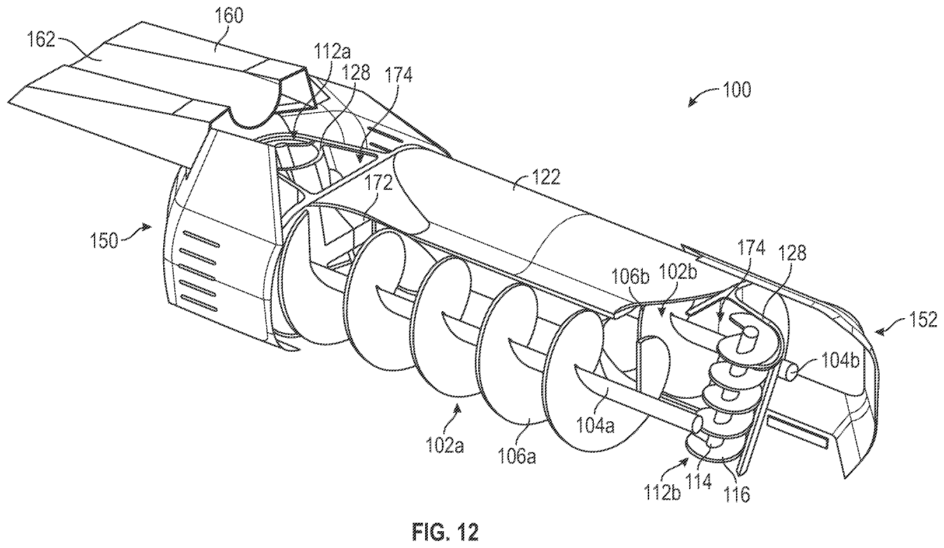

Referring particularly to FIGS. 3 and 12, each of the first discharge screw 112a and the second discharge screw 112b include a shaft 114 and a helical surface 116 that forms the screws 112. In some embodiments, the shaft 114 extends along an axis 110. In particular, the first discharge screw 112a extends along a first axis 110a and the second discharge screw 112b extends along a second axis 110b. In some embodiments, the first discharge screw 112a and the second discharge screw 112b are angled relative to the longitudinal axis 168 of the twin screw mixer system 100 by an angle 120. The first axis 110a extends in a direction at least partially towards the front end 36 of the mixer vehicle 10 at the angle 120 relative to the longitudinal axis 168 of the mixer drum 122. The second axis 110b extends in a direction at least partially rearwards towards the rear end 38 of the mixer vehicle 10 at the angle 120 relative to the longitudinal axis 168 of the mixer vehicle 10. In some embodiments, the discharge screws 112 are replaceable with pumps so that the slurry material can be discharged by pumping the slurry material out of the mixer drum 122.

Referring to FIGS. 4 and 12, the sidewalls 128 can also define separate channels 174 (e.g., charge chutes) that fluidly couple with both the first inner volume 126a and the second inner volume 126b through an opening 132b. In some embodiments, the opening 132b is formed in the sidewalls 166 and provides a separate channel for access to the first inner volume 126a and the second inner volume 126b. In some embodiments, only one end of the twin screw mixer system 100 includes the channel 174. In some embodiments, both ends of the twin screw mixer system 100 include the channels 174. In some embodiments, the channels 174 facilitate access to the first inner volume 126a and the second inner volume 126b such that additives, materials, water, etc., can be added to the first inner volume 126a and the second inner volume 126b to obtain a desired consistency of the slurry material. Advantageously, the mixer drum 122 can include two charge chutes (e.g., channels 174) such that slurry material can be added to the mixer drum 122.

Referring again to FIGS. 3 and 12, the first discharge screw 112a and the second discharge screw 112b can be operated to drive or lift the slurry material out of the first inner volume 126a and the second inner volume 126b to provide the slurry material to the front discharge system 200 or the rear discharge system 300. In some embodiments, the first discharge screw 112a can operate or rotate to discharge the slurry material out of the mixer drum 122 to the front discharge system 200. Similarly, the second discharge screw 112b can operate or rotate to discharge the slurry material out of the mixer drum 122 to the rear discharge system 300, as desired by an operator of the mixer vehicle 10. In some embodiments, the twin screw mixer system 100 includes a structural member, shown as shroud 164 that supports a material guide member 160. The material guide member 160 may be a structural member or define one or more surfaces and is configured to guide the slurry material after it is discharged by the first discharge screw 112a to the front discharge system 200. The material guide member 160 can define an upward-facing, longitudinal channel, shown as open channel 162 (e.g., a surface, a recessed surface, an aqueduct, etc.). The open channel 162 may extend at least partially downwards or sloped downwards along the material guide member 160 such that forces of gravity cause the slurry material to flow along, pour along, dispense along, travel along, or otherwise transport along the open channel 162 to the front discharge system 200 for pouring at the job site or work site. In some embodiments, the material guide member 160 includes or defines a tubular member or pipe for transporting the slurry material to the front discharge system 200.

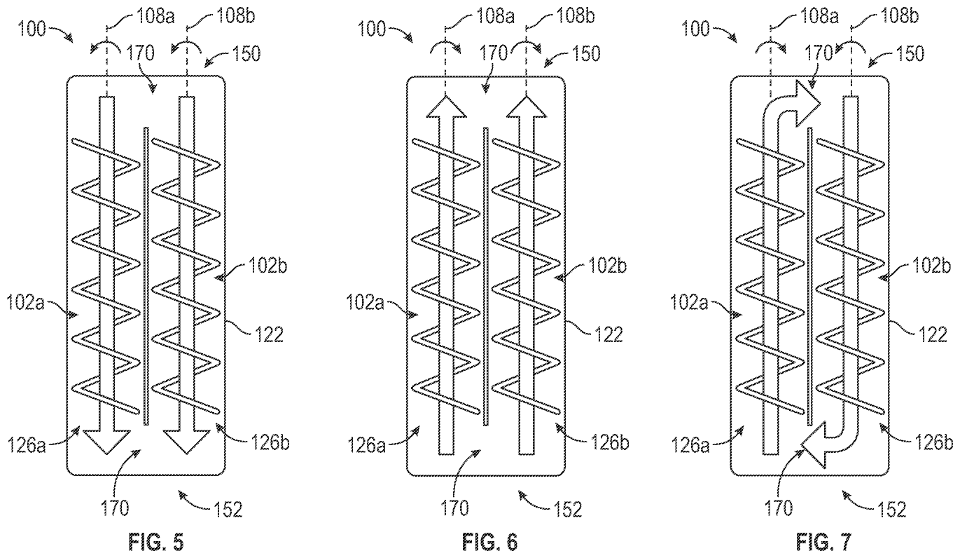

Referring to FIGS. 5-7, the twin screw mixer system 100 is shown operating according to different modes to either discharge the slurry material through the rear discharge system 300, discharge the slurry material via the front discharge system 200, or to mix the slurry material during transportation of the mixer vehicle 10 (e.g., when the mixer vehicle 10 is not pouring the slurry material). Referring particularly to FIG. 5, the first screw 102a and the second screw 102b may be driven to rotate about their corresponding axes 108a and 108b, respectively, in a first direction (e.g., a clockwise direction) to drive the slurry material towards the second longitudinal end 152 of the mixer drum 122 for discharge of the slurry material via the rear discharge system 300. In some embodiments, the second discharge screw 112b is driven to discharge the slurry material out of the mixer drum 122 while the first screw 102a and the second screw 102b operate to rotate in the first direction such that the slurry material is driven to exit the mixer drum 122 and provided to the rear discharge system 300 for dispensing or pouring at the rear end 38 of the mixer vehicle 10. In this way, the slurry material may be driven towards the second longitudinal end 152 by operation of the first screw 102a and the second screw 102b, discharge through the window 132a at the second longitudinal end 152, and be driven by operation of the second screw 112b to travel through the inner volume 130 at the second longitudinal end 152 of the twin screw mixer system 100 and be dispensed or poured by the rear discharge system 300 (e.g., to direct the flow of slurry material to a desired location on the job site or work site that is rearwards of the mixer vehicle 10).

Referring to FIG. 6, the first screw 102a and the second screw 102b may be driven to rotate about their corresponding axes 108a and 108b, respectively, in a second direction (e.g., a counter-clockwise direction) in order to drive the slurry material towards the first longitudinal end 150 of the mixer drum 122 for discharge of the slurry material via the front discharge system 200. In some embodiments, the first discharge screw 112a is driven to discharge the slurry material out of the mixer drum 122 while the first screw 102a and the second screw 102b operate to rotate in the second direction such that the slurry material is driven to exit the mixer drum 122 and provided to the front discharge system 200 for dispensing or pouring at the front end 36 of the mixer vehicle 10. In this way, the slurry material may be driven towards the first longitudinal end 150 by operation of the first screw 102a and the second screw 102b, discharge through the window 132a at the first longitudinal s 150, and be driven by operation of the first screw 112a to travel through the inner volume 130 at the first longitudinal end 150 of the twin screw mixer system 100 and be dispensed or poured by the front discharge system 200 (e.g., to direct the flow of slurry material to a desired location on the job site that is forwards of the mixer vehicle 10).

Referring particularly to FIG. 7, the first screw 102a and the second screw 102b may be driven to rotate about their corresponding axes 108a and 108b, respectively, in opposite directions (e.g., the first screw 102a being driven about the axis 108a in the counter-clockwise direction and the second screw 102b being driven about the axis 108b in the clockwise direction or vice versa) in order to drive the slurry material within the mixer drum 122 to be exchanged between the first inner volume 126a and the second inner volume 126b in order to mix the slurry material. In some embodiments, the slurry material is driven by the first screw 102a to exit the first inner volume 126a and enter the second inner volume 126b through the opening 170 at the first longitudinal end 150 of the mixer drum 122. In some embodiments, the slurry material is driven by the second screw 102a to exit the second inner volume 126b and enter the first inner volume 126a through the opening 170 at the second longitudinal end 152 of the mixer drum 122 in order to facilitate mixing the slurry material. In some embodiments, the first discharge screw 112a and the second discharge screw 112b are not operated, or are operated to drive in a reverse direction, when the twin screw mixer system 100 is operated to mix the slurry material as shown in FIG. 7. Advantageously, the twin screw mixer system 100 facilitates improved stability of mixing the slurry material during transportation of the mixer vehicle 10.

### Mixer Drum Center of Gravity

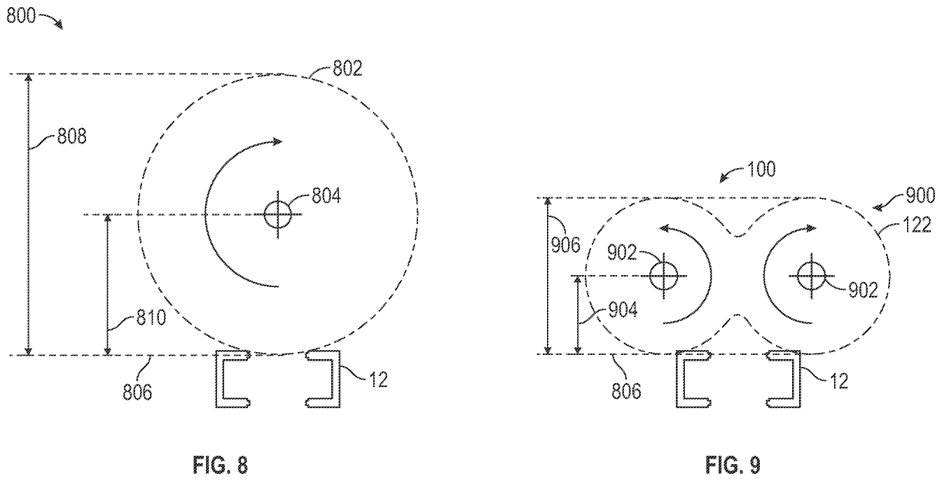

Referring to FIGS. 8 and 9, a diagram 800 illustrates a center of gravity 804 and a height 808 of a single drum 802, and a diagram 900 illustrates a center of gravity 902 and a height 906 of the twin screw mixer system 100, according to some embodiments. As shown in FIGS. 8 and 9, the twin screw mixer system 100 has height 906 relative to an intersection point 806 between the mixer drum 122 and the frame, which is less than height 808 of the single drum 802 relative to the intersection 806. Further, the center of gravity 902 of the mixer drum 122 is a distance 904 from the intersection 806 which is significantly reduced (e.g., less than) the distance 810 of the center of gravity 804 of the single drum 802. Advantageously, the twin screw mixer system 100 has a reduced height, a reduced or lowered center of gravity, and may have increased volume or capacity relative to the single drum 802 shown in diagram 800.

### Screw Drive Systems

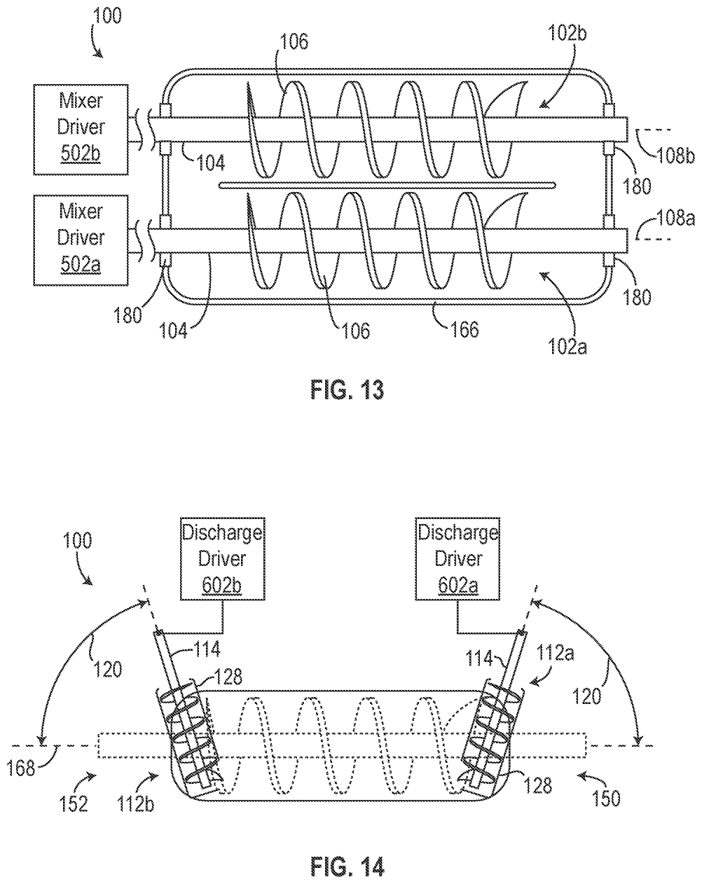

Referring to FIGS. 13-14, the first screw 102a and the second screw 102b may be driven by a mixer driver 502a and a mixer driver 502b in order to mix the slurry material within the mixer drum 122. In some embodiments, the mixer driver 502a is coupled with the first screw 102a and is configured to drive the first screw 102a in either direction. Similarly, the mixer driver 502b can be coupled with the second screw 102b and drive the second screw 102b in either direction. In some embodiments, the mixer driver 502a and the mixer driver 502b are configured to operate cooperatively in order to drive the first screw 102a and the second screw 102b to perform the rear discharge as shown in FIG. 5, the front discharge as shown in FIG. 6, or to perform the mixing as shown in FIG. 7. In some embodiments, the mixer driver 502a and the mixer driver 502b are electric motors. In some embodiments, the mixer driver 502a and the mixer driver 502b are hydraulic motors. In some embodiments, the mixer driver 502a and the mixer driver 502b are configured to provide reduced torque output to thereby provide increased speed and improved mixing of the slurry material. In some embodiments, the screws 102a and 102b have a reduced rotational inertia compared to a mixer drum that rotates at an angle, and therefore can be driven at faster speeds to mix the slurry material more quickly.

Referring particularly to FIG. 13, the shafts 104 of the first mixer screw 102a and the second mixer screw 102b are configured to be supported by and sealingly couple with one or more bearings 180 that are coupled with or positioned within openings (e.g., apertures) of the sidewall 166. In some embodiments, the bearings 180 are thrust bearings that include one or more seals configured to engage an outer surface of the shafts 104

Referring to FIG. 14, the first discharge screw 112a and the second discharge screw 112b can be independently driven by a discharge driver 602a and a discharge driver 602b. In some embodiments, the discharge driver 602a and the discharge driver 602b are electric motors or hydraulic motors. In some embodiments, the discharge driver 602a and the discharge driver 602b are configured to couple with the shafts 114 of the first discharge screw 112a and the second discharge screw 112b. The discharge driver 602a and the discharge driver 602b can be operated cooperatively to perform a front discharge or rear discharge of the slurry material. In some embodiments, the discharge driver 602a and the discharge driver 602b are configured to operate to drive in either direction in order to discharge or maintain the slurry material within the mixer drum 122.

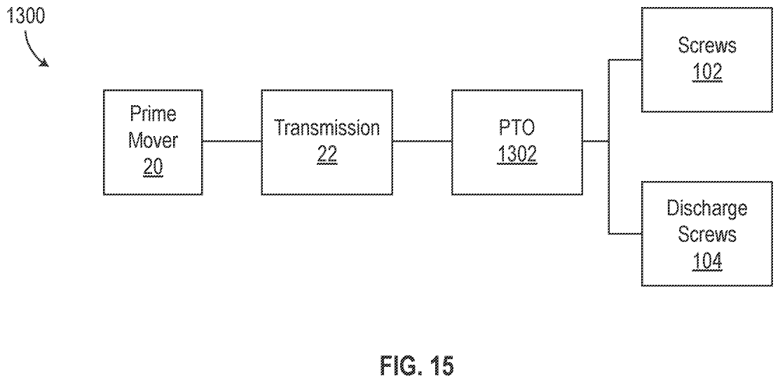

Referring to FIG. 15, the screws 102 and/or the discharge screws 112 may be driven by the prime mover 20 through a driveline 1300, according to some embodiments. In some embodiments, the prime mover 20 is configured to drive the transmission 22. Mechanical energy (e.g., rotational energy) can be transferred to the screws 102 and/or the discharge screws 112 through a power take off (PTO) 1302 that selectably drives off the transmission 22. In some embodiments, the PTO 1302 couples with the screws 102 and/or the discharge screws 112 through one or more clutches, gear trains, gearing systems, etc.

### Chassis Arrangement

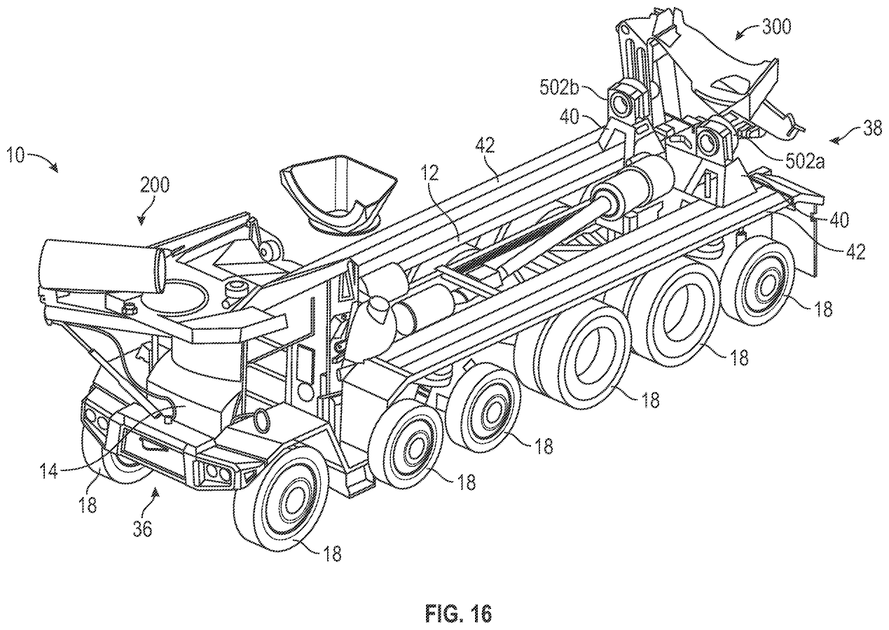

Referring to FIG. 16, the mixer vehicle 10 is shown with the twin screw mixer system 100 removed. In some embodiments, the twin screw mixer system 100 is removably coupled (e.g., fastened) to the chassis 12 and one or more rails 42 that extend longitudinally from a location proximate the cab 14 to the rear end 38 of the mixer vehicle 10. In some embodiments, the mixer drum 122 is removably coupled from the chassis 12 and the rails 42. The rails 42 may define a flat surface for the mixer drum 122 to rest upon. In some embodiments, the screws 102 and the screws 112 are removably coupled with the mixer drum 122. For example, the mixer drum 122 may include separate portions that can be removed. In some embodiments, the screws 102 are removable from the interior of the mixer drum 122 for replacement and servicing.

Referring still to FIG. 16, the mixer vehicle 10 includes a pair of mounts 40 positioned at the rear end 38 of the rails 42. In some embodiments, the mixer driver 502a and the mixer driver 502b are positioned on the mounts 40 such that the mixer driver 502a and the mixer driver 502b can operate to drive the screws 102 to mix or discharge the slurry material (e.g., via the front discharge system 200 or via the rear discharge system 300).

### Screw Configuration

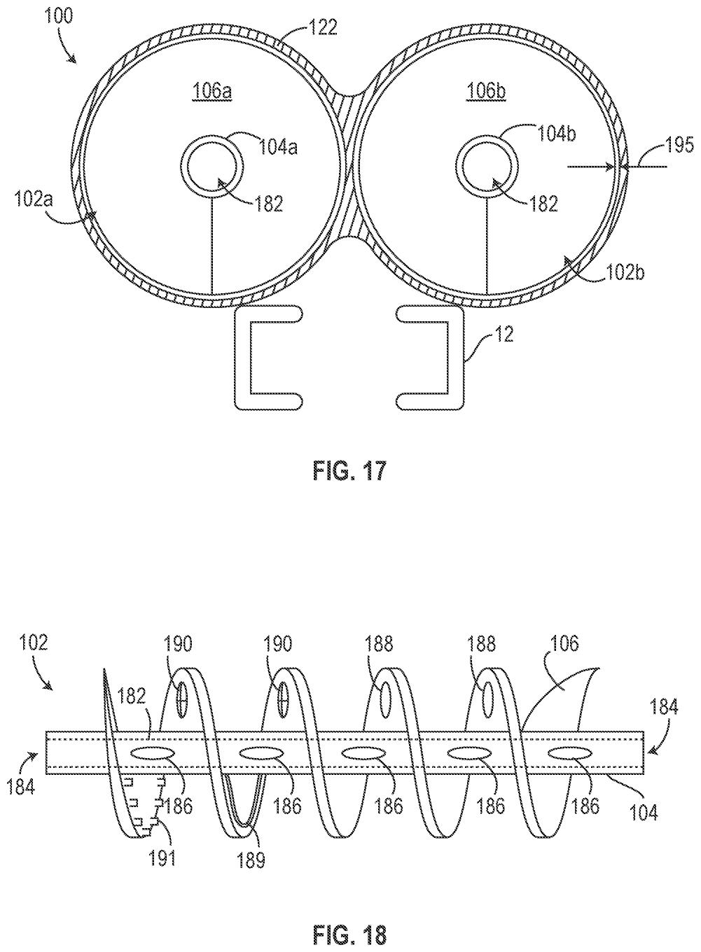

Referring particularly to FIG. 17, the screws 102 each include a bore 182 extending centrally through the shaft 104a and the shaft 104b, thereby resulting in hollow shafts. The hollow shafts 104 can facilitate transfer of the slurry material from one end of the screws 102 to an opposite end of the screws 102. In some embodiments, the transfer of slurry material within the shafts 104 of the screws 102 facilitates improved mixing of the slurry material. In some embodiments, an inner surface of the shafts 104 include protrusions (e.g., barbs, bumps, etc.) to facilitate mixing the slurry material. In some embodiments, the bores 182 are accessible from at least one end of the shaft 104 such that an additive, water, etc., can be provided to the mixer drum 122 from an exterior of the mixer drum 122 to obtain a desired consistency of the slurry material.

As shown in FIG. 17, a gap 195 is formed between an outer surface of the helical surfaces 106 (e.g., an outer periphery, an outer edge, an outer face, etc.) and an interior surface of the mixer drum 122. In some embodiments, the gap 195 is uniform along a longitudinal length of the screws 102. In some embodiments, the gap 195 is variable along the longitudinal length of the screws 102, with the gap 195 having a smaller or even negligible value along a longitudinally central portion of the screws 102 and a larger or non-negligible value along longitudinal end portions of the screws 102. In some embodiments, the helical surfaces 106 are configured to abut, engage, or scrape the interior surface of the mixer drum 122 at one or more locations along the longitudinal length of the screws 102 to facilitate mixing and reduce buildup of the slurry material on the interior surface of the mixer drum 122.

### Hollow Shaft Screws

Referring particularly to FIG. 18, one of the screws 102 may include the hollow shaft 104 having the bore 182 extending centrally through the shaft 104, with openings 184 on either end of the shaft 104. In some embodiments, the openings 184 fluidly couple the bore 182 with an exterior of the mixer drum 122. In some embodiments, the shaft 104 also includes one or more openings 186 along the shaft 104 that fluidly couple the bore 182 with the interior of the mixer drum 122 (e.g., with the first inner volume 126a and/or the second inner volume 126b). In some embodiments, the openings 186 are elliptical or circular. In some embodiments, the shaft 104 also includes one or more protrusions or agitators configured to facilitate mixing the slurry material. In some embodiments, the helical surfaces 106 include one or more openings 188 that extend through a thickness or width of the helical surfaces 106. In some embodiments, the openings 188 allow the transfer of the slurry material through the helical surfaces 106 to thereby facilitate improved mixing of the slurry material. In some embodiments, the helical surfaces 106 include one or more surface grooves 189 that extend along the helical surfaces 106 (e.g., helically, radially outwards, laterally, etc.).

### Screw Mixing Features

Referring still to FIG. 18, the helical surfaces 106 may also include protrusions 190 and/or extensions 191. The protrusions 190 may have an elliptical shape or a circular shape and can have a structural form such as bumps, smooth protrusions, etc. The extensions 191 may have a jagged form (e.g., square protrusions that extend from the helical surfaces 106) and facilitate agitating or mixing the slurry material. In some embodiments, the helical surfaces 106 include surface protrusions that extend continuously about the helical surfaces 106. In some embodiments, the openings 184 allow or facilitate a washout from the exterior of the mixer drum 122. For example, a tubular member or a fluid conduit may be fluidly coupled with the openings 184 such that pressurized water can be discharged into the bore 182 to thereby clear debris or slurry material after the slurry material has been discharged from the mixer drum 122 during a working or pouring operation.

Screw with Internal Passageway

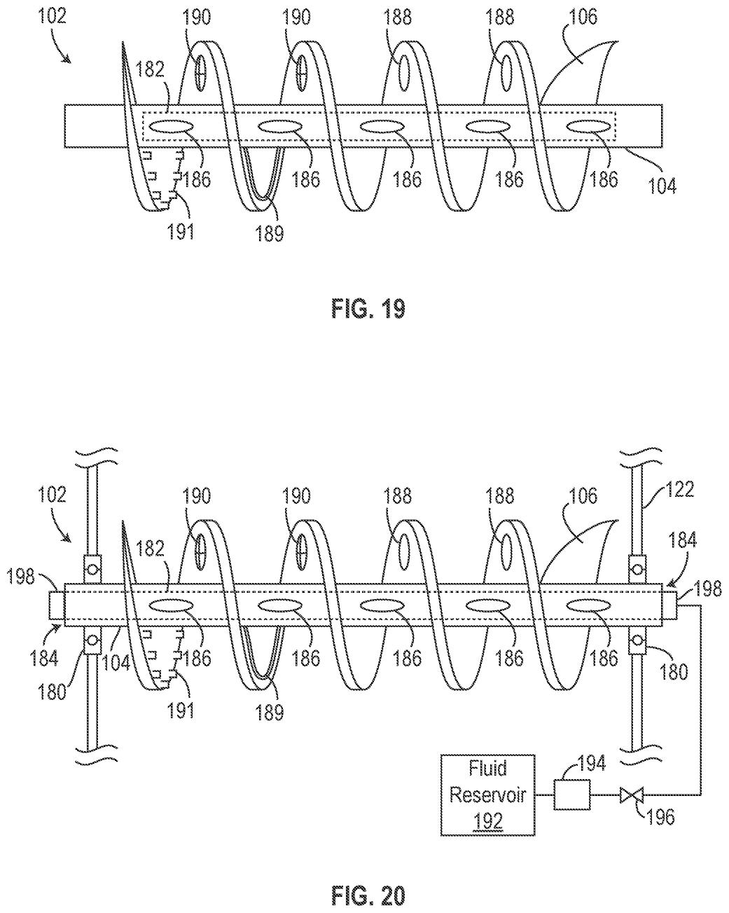

Referring to FIG. 19, the bore 182 may extend between the different openings 186 on the shaft 104, but not extend to the ends of the shaft 104. In this way, the bore 182 and the openings 186 can provide a fluid path between opposite ends of the mixer drum 122 so that slurry material can transfer between the opposite ends of the mixer drum 122. In some embodiments, the shaft 104 includes helical surfaces or screw surfaces extending along the inner cylindrical surface defined by the bore 182 to thereby bias the slurry material between opposite ends of the mixer drum 122.

### Washout System

Referring particularly to FIG. 20, the bore 182 may extend to the ends of the shaft 104 which may be selectably closed by stoppers 198. The stoppers 198 can be threaded or compression fit into the ends of the shaft 104 to fluidly decouple the bore 182 from the exterior of the mixer drum 122. The stoppers 198 may be removed or define an opening that can be fluidly coupled with a tubular member. A fluid reservoir 192, a pump 194, and a one-way valve 196 may be fluidly coupled with the bore 182. The pump 194 may operate to discharge liquid or fluid from the fluid reservoir 192 into the bore 182 of the shaft 104 to thereby clean or discharge built up slurry material within the mixer drum 122.

### Screw Tips

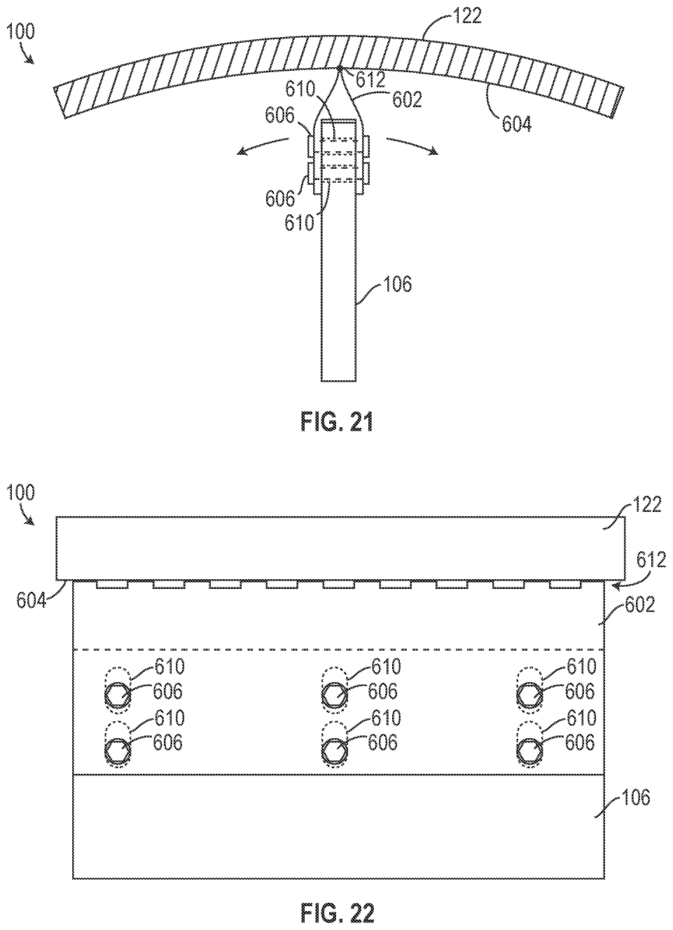

Referring particularly to FIGS. 21 and 22, the helical surfaces 106 of the screws 102 may include a rubber or polymeric fin 602 that is removably coupled with an end portion of the helical surfaces 106. In some embodiments, the fins 602 are fastened onto the helical surfaces 106 via fasteners 606 that extend through openings 610 of the helical surfaces 106. The fin 602 may be removable and replaceable and is configured to engage an interior surface 604 of the mixer drum 122 along an outer portion 612. In some embodiments, the openings 610 are slots such that the fasteners 606 can be loosened, and the fin 602 can adjusted and fastened at a desired location along the helical surfaces 106. In some embodiments, the outer portion 612 has a jagged edge or an edge that engages or contacts the interior surface 604 along some locations, but forms a gap between the interior surface 604 and the fin 602 at other locations. In some embodiments, the fin 602 is made from a flexible material so that the fin 602 bends while being driven to rotate relative to the mixer drum 122.

Screw with Variable Flight Spacing

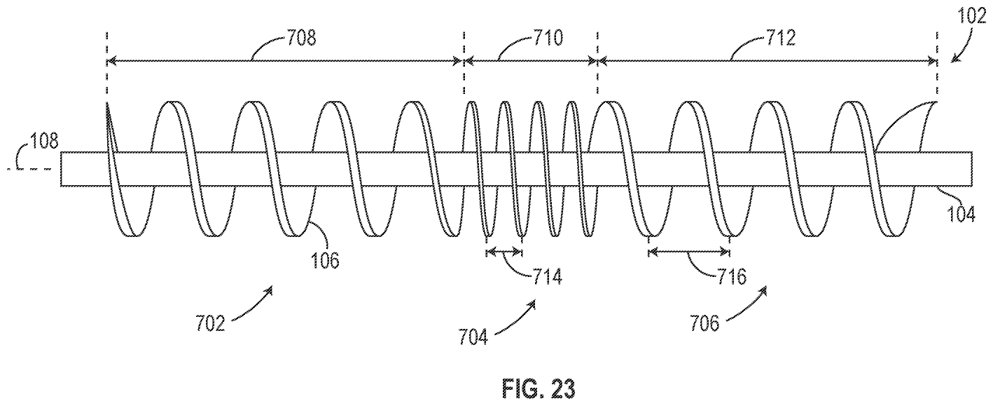

Referring to FIG. 23, any of the screws 102 may have a variable pitch or flight spacing along the longitudinal axis 108 of the screw 102. For example, the screw 102 may include a first section 702, a second section 704, and a third section 706 having different values of pitch or flight spacing. In some embodiments, the first section 702 extends along a first longitudinal distance 708 of the screw 102, the second section 704 extends along a second longitudinal distance 710 of the screw 102, and the third section 706 extends along a third longitudinal distance 712 of the screw 102. In some embodiments, the second section 704 has a pitch 714 that is less than a pitch 716 of the helical surfaces 106 along the first portion 702 and the third portion 706. In some embodiments, the second section 704 is a medial portion with the first section 702 and the third section 706 positioned on opposite ends of the second section 704. In some embodiments, the transition between the first section 702, the second section 704, and the third section 706 (e.g., the change in pitch or flight spacing) is discrete as shown in FIG. 23. In some embodiments, the transition of the pitch or the flight spacing of the helical surfaces 106 is continuous along the longitudinal length of the screw 102. In some embodiments, a medial portion has a smaller value of the pitch or the flight spacing. In some embodiments, the medial portion has a larger value of the pitch or the flight spacing. In some embodiments, the different values of the pitch or the flight spacing of the helical surfaces 106 facilitates adjusting or changing the pressure exerted on the slurry material at different longitudinal locations along the screw 102, or adjusting or changing a speed at which the slurry material is mixed.

In some embodiments, the screw 102 includes helical surfaces 106 at opposite ends having both flight directions (e.g., both a counter-clockwise wind and a clockwise wind or direction) such that the slurry material is driven to a center of the mixer drum 122 (e.g., away from the ends of the mixer drum 122) for discharge at a center point of the mixer drum 122. In this way, the helical surfaces 106 can bias the slurry material towards the center of the mixer drum 122 to facilitate improved discharge (e.g., vertical discharge through a top of the mixer drum 122 at a longitudinal center of the mixer drum 122, vertical discharge through a bottom of the mixer drum 122 at the longitudinal center of the mixer drum 122, through sides of the mixer drum 122 proximate a longitudinal center of the mixer drum 122, etc.).

Screw with Variable Shaft Diameter

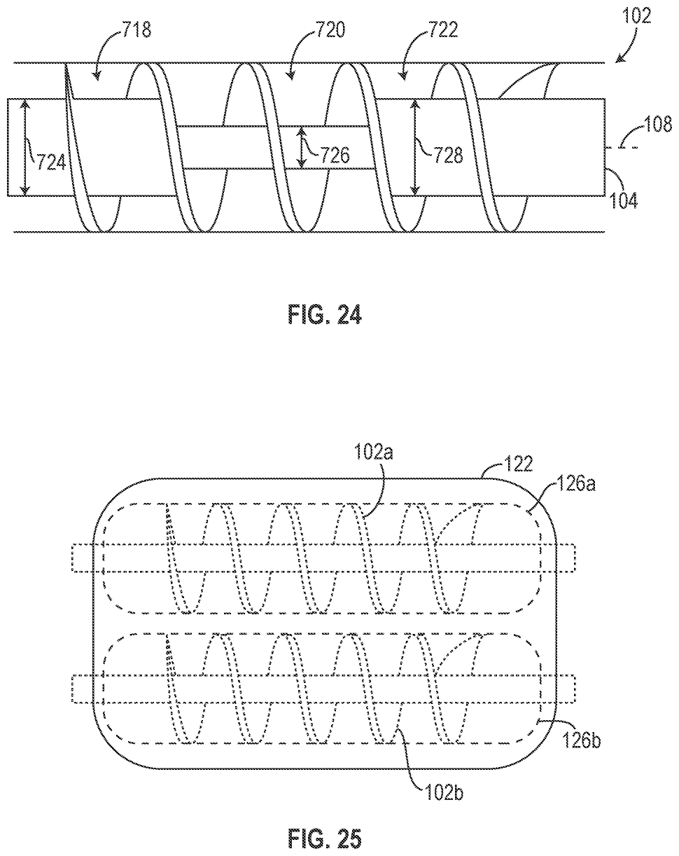

Referring to FIG. 24, the screw 102 may have a variable diameter of the shaft 104 along a longitudinal length of the screw 102. In some embodiments, the shaft 104 includes a first portion 718, a second portion 720, and a third portion 722. In some embodiments, the first portion 718 and the third portion 722 have diameters 724 and 728 that are greater than a diameter 726 of the shaft 104 along the second portion 720. In some embodiments, the change in diameter of the shaft 104 along the longitudinal length of the screw 102 are discrete. In some embodiments, the change in diameter of the shaft 104 along the longitudinal length of the screw 102 are continuous. In some embodiments, portions of the shaft 104 that have increased diameter result in decrease volume, which in turn increases pressure exerted on the slurry material along the portion with increased diameter.

### Separate Cavity Mixer Drum

Referring to FIG. 25, the first inner volume 126a and the second inner volume 126b can be fluidly independent (e.g., without any cross-channels or inner volumes between them) such that the first inner volume 126a and the second inner volume 126b can be configured to store different types of materials. In some embodiments, the first inner volume 126a and the second inner volume 126b can separately store, mix, and discharge the different types of material (e.g., asphalt and cement, different types of slurry materials, etc.). In some embodiments, a discharge system is configured to draw the slurry material from the first inner volume 126a or the second inner volume 126b in a selectable or divertible manner (e.g., using a valve that transitions between the first inner volume 126a and the second inner volume 126b). In some embodiments, the mixer truck 10 includes separate discharge systems, one for each of the separate cavities.

### Three Cavity Mixer Drum

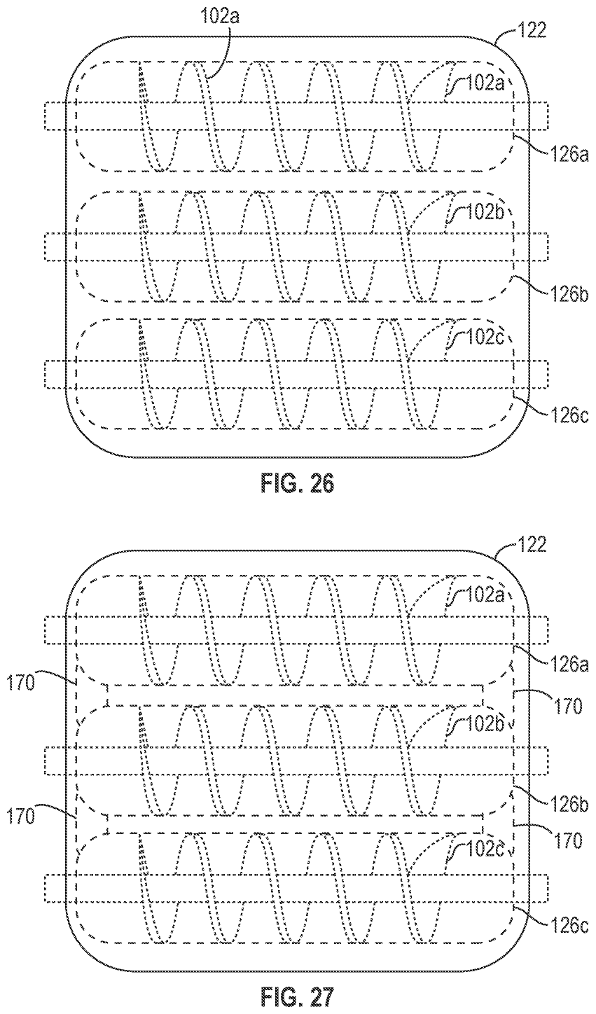

Referring to FIGS. 26-27, the mixer drum 122 may include three inner volumes or chambers, shown as the first inner volume 126a, the second inner volume 126b, and a third inner volume 126c. The mixer drum 122 further includes the first screw 102a position within the first inner volume 126a, the second screw 102b position within the second inner volume 126b, and a third screw 102c positioned within the third inner volume 126c. The first inner volume 126a, the second inner volume 126b, and the third inner volume 126c may be fluidly decoupled and separate from each other as shown in FIG. 26 (e.g., for storing, mixing, and discharging three separate materials), or be fluidly coupled with each other through passages, shown as openings 170 such that a single mixture of slurry material is exchanged between the inner volumes 126. It should be understood that the mixer drum 122 may have any number of cavities and any number of screws 102 (e.g., more than three). In some embodiments, both the first screw 102a and the third screw 102c are deadheaded (e.g., drive slurry material towards an end of the mixer drum 122 that does not include an outlet, or includes an outlet that is sealed shut) and have a same flight direction of the helical surfaces 106, while the second screw 102b (that is positioned between the first screw 102a and the third screw 102c) has an opposite flight direction and is configured to draw the slurry material away from the end that the first screw 102a and the third screw 102c such that the slurry material circulates through the mixer drum 122.

### Chain Driven Screws

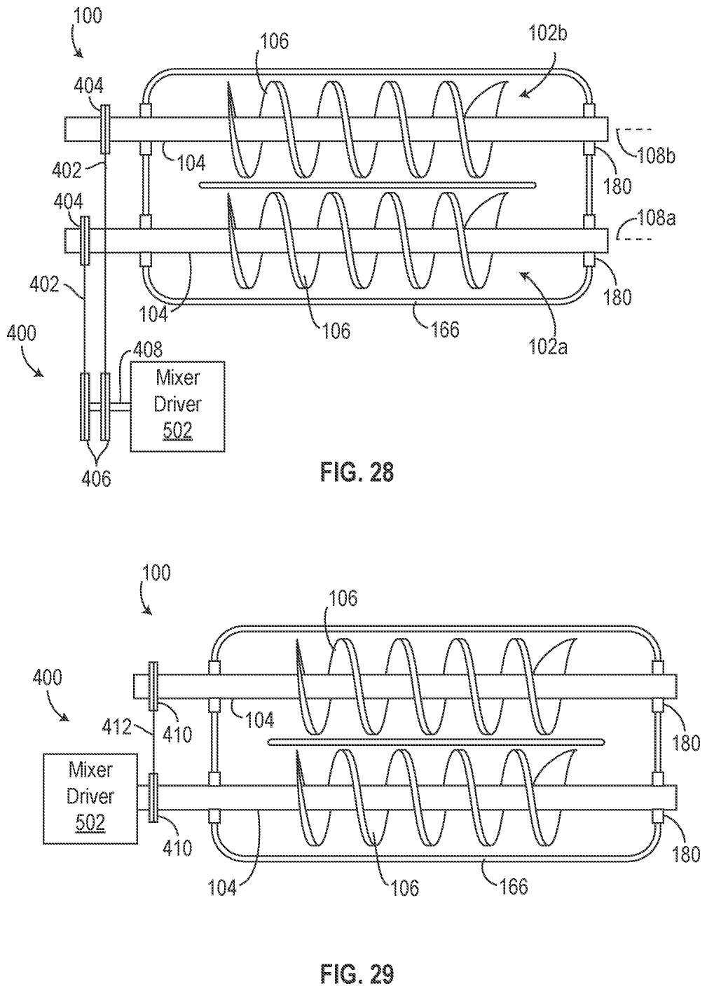

Referring to FIGS. 28 and 29, the screws 102 may be driven by a chain drive system 400. In some embodiments, the chain drive system 400 includes the mixer driver 502 (e.g., a hydraulic motor) and is configured to drive the screws 102 at a same speed and in a same direction. Referring to FIG. 28, in some embodiments, the mixer driver 502 is configured to drive an output shaft 408 that includes sprockets 406 mounted on the shaft 408, and which are coupled with sprockets 404 that are mounted onto the shafts 104 of the screws 102. The sprockets 406 of the shaft 408 are coupled with the sprockets 404 of the shafts 104 of the screws 102 through chains 402. Referring to FIG. 29, in some embodiments, the mixer driver 502 is configured to directly drive one of the shafts 104 of the screws 102. Both of the shafts 104 of the screws 102 include a sprocket 410 mounted upon the shafts 104 of the screws 102, which are linked through a chain 412. In this way, driving rotation of one of the screws 102 causes corresponding rotation at the other screw 102. In some embodiments, the screws 102 are driven using a ribbon-drive system. In some embodiments, the screws 102 rotate in opposite directions during mixing.

Single Cavity with Two Screws

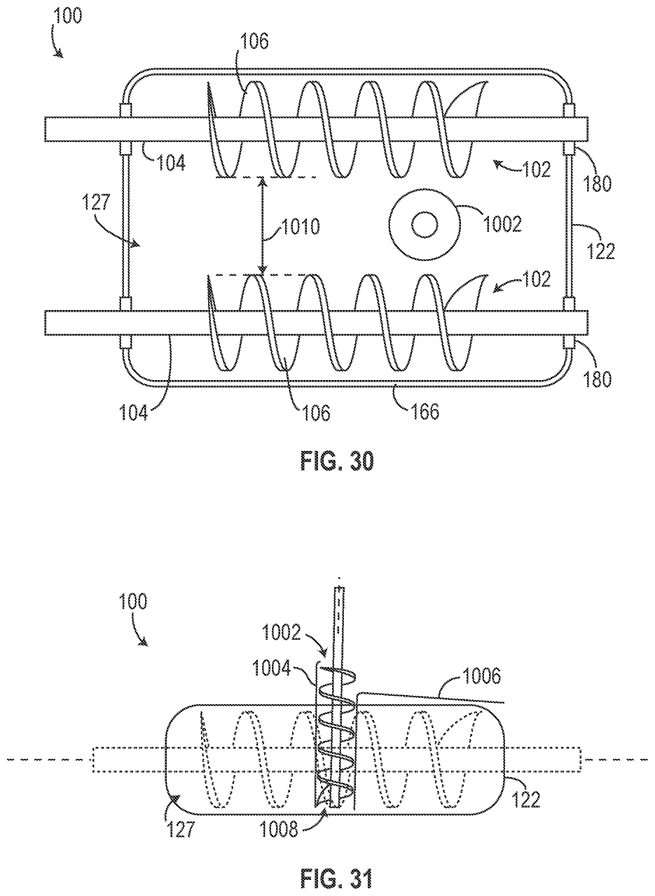

Referring to FIGS. 30-31, the mixer drum 122 may have a single cavity, shown as inner volume 127. In some embodiments, the two screws 102 are positioned within the inner volume 127 at opposite ends of the mixer drum 122. For example, a space or gap 1010 may be defined between the screws 102. The screws 102 may be parallel as shown, or may be non-parallel (e.g., extending towards each other at one end). In some embodiments, a discharge screw 1002 that is the same as or similar to the discharge screws 112 is positioned between the screws 102. In some embodiments, the discharge screw 1002 is positioned within a tubular member 1004 having an open end 1008. The discharge screw 1002 may operate (e.g., rotate) to drive the slurry material out of the inner volume 127 through the tubular member 1004. In some embodiments, the tubular member 1004 includes a chute or angled surface 1006 that is configured to direct the slurry material in a discharge direction or towards a discharge system. In some embodiments, the screws 102 shown in FIG. 30 are configured to drive the slurry material to travel in a circular path within the inner volume 127 to mix the slurry material.

### Top Drum Opening

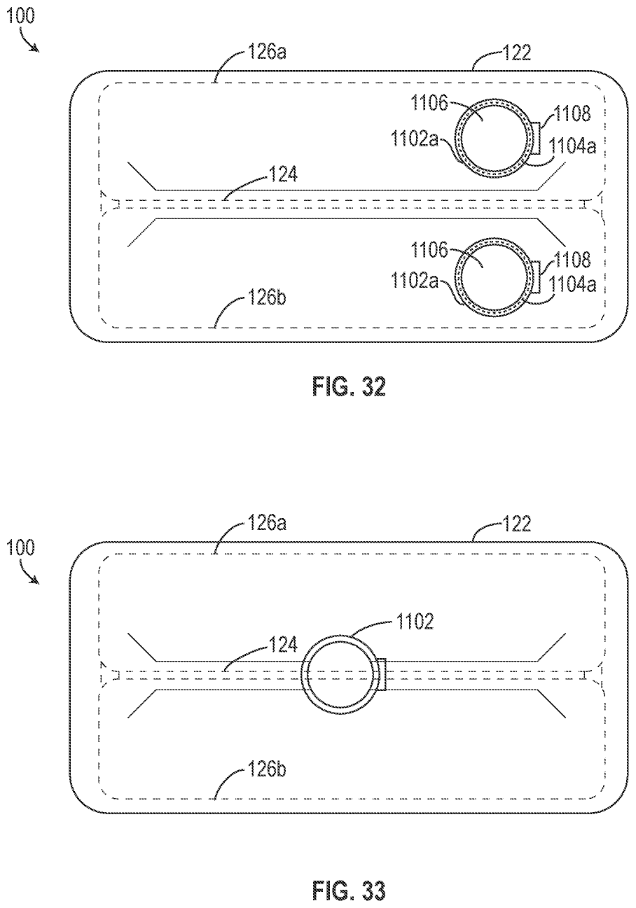

Referring to FIGS. 32-33, the mixer drum 122 can include one or more top openings or doors 1102 that are configured to facilitate access to the inner volumes 126 for loading or mixing material or additives to the mixer drum 122. Referring to FIG. 32, the mixer drum 122 may include a first door 1102a positioned above the first inner volume 126a and a second door 1102b positioned above the second inner volume 126. The first door 1102a and the second door 1102b can be selectively transitioned between a closed position and an open position to expose a first opening 1104a, and a second opening 1104b, respectively. In some embodiments, the first opening 1104a is configured to facilitate access to the first inner volume 126a, and the second opening 1104b is configured to facilitate access to the second inner volume 126b. In some embodiments, each of the doors 1102 includes a cover 1106 and a hinge 1180, and can be unlocked, transitioned between the open position and the closed position, and locked in the closed position. In some embodiments, the doors 1102 have the form of a trap door or a slidable panel. Referring to FIG. 33, one of the doors 1102 may be positioned above the divider 124 such that the opening which the door 1102 covers can facilitate access to both the first inner volume 126a and the second inner volume 126b simultaneously. In some embodiments, the door 1102 can be positioned at a center of the mixer drum 122, at a rear of the mixer drum 122, or at both the center and the rear of the mixer drum 122 to accommodate loading at different facilities or plants.

### Top Door Covering

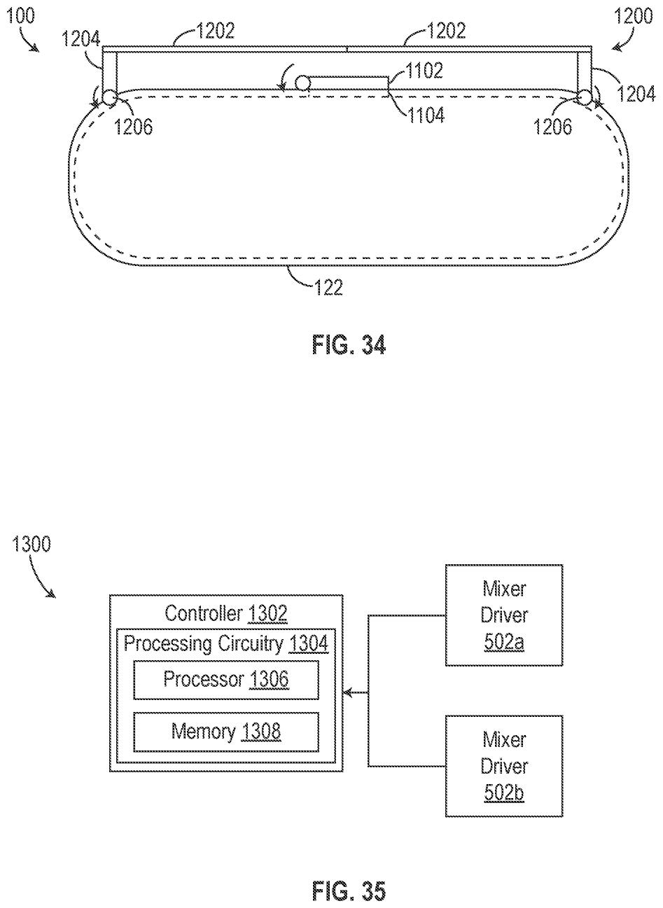

Referring to FIG. 34, the door 1102 that facilitates or allows access to the inner volume 126 of the mixer drum 122 may be selectively covered by a top door system 1200. In some embodiments, the top door system includes panels 1202 that can be selectively driven to open and allow access to the door 1102, or closed to limit access to the door 1102. In some embodiments, the top door system 1200 includes linkages 1204 that are pivotally coupled with couplings 1206 and configured to drive the panels 1202 between the open position and the closed position. In some embodiments, the linkages 1204 are driven by electric motors. In some embodiments, the panels 1202 are configured to translate along a track through a slewing drive, a rack and pinion drive system, etc., to transition between the open position and the closed position.

### Control System

Referring to FIG. 35, a control system 1300 for the mixer vehicle 10 includes a controller 1302 configured to receive feedback from the mixer driver 502a and the mixer driver 502b. Controller 1302 is shown to include a circuit, shown as processing circuitry 1304, a processor, shown as processor 1306, and memory, shown as memory 1308, according to an exemplary embodiment. Controller 1302 may be implemented as a general-purpose processor, an application specific integrated circuit (ASIC), one or more field programmable gate arrays (FPGAs), a digital-signal-processor (DSP), circuits containing one or more processing components, circuitry for supporting a microprocessor, a group of processing components, or other suitable electronic processing components. According to the exemplary embodiment shown in FIG. 35, controller 1302 includes processing circuitry 1304 and a memory 1308. Processing circuitry 1304 may include an ASIC, one or more FPGAs, a DSP, circuits containing one or more processing components, circuitry for supporting a microprocessor, a group of processing components, or other suitable electronic processing components (e.g., processor 1306). In some embodiments, processing circuitry 1034 is configured to execute computer code stored in memory 1308 to facilitate the activities described herein. Memory 1308 may be any volatile or non-volatile computer-readable storage medium capable of storing data or computer code relating to the activities described herein. According to an exemplary embodiment, memory 1308 includes computer code modules (e.g., executable code, object code, source code, script code, machine code, etc.) configured for execution by processing circuitry 1304. Memory 1308 includes various actuation profiles corresponding to modes of operation, according to an exemplary embodiment. In some embodiments, controller 1302 may represent a collection of processing devices (e.g., servers, data centers, etc.). In such cases, processing circuitry 1304 represents the collective processors of the devices, and memory 304 represents the collective storage devices of the devices.

In some embodiments, the controller 1302 is configured to generate control signals for the mixer driver 502a, the mixer driver 502b, the various actuators of the front discharge system 200 and the rear discharge system 300, the discharge screws 112, etc., or any other controllable element of the mixer vehicle 10. In some embodiments, the controller 1302 is configured to control the controllable elements of the mixer vehicle 10 according to a selected mode (e.g., to mix, increase spin speed of the screws 102 for washout, front discharge, rear discharge, etc.).

In some embodiments, the controller 1302 is configured to obtain feedback from the mixer drivers 502 and determine a slump or consistency of the slurry material based on the feedback from the mixer drivers 502. If the mixer drivers 502 are electric motors, the controller 1302 may monitor amperage draw of the mixer drivers 502 and determine slump based on the amperage draw (e.g., high amp draw may indicate low slump, whereas low amp draw may indicate higher slump). Similarly, if the mixer drivers 502 are hydraulic motors, the controller 1302 may monitor hydraulic pressure of the mixer drivers 502 and determine slump based on the hydraulic pressure (e.g., high pressure may indicate low slump, whereas low pressure may indicate higher slump). In some embodiments, the controller 1302 is configured to adjust operation of the mixer drivers 502 based on the determined slump or notify an operator that an additive should be added to change the slump. In some embodiments, the controller 1302 is configured to perform a comparison to identify differences between amperage feedback or pressure feedback from the mixer drivers 502 to determine one or more properties of the slurry material.

### Discharge Conveyor System

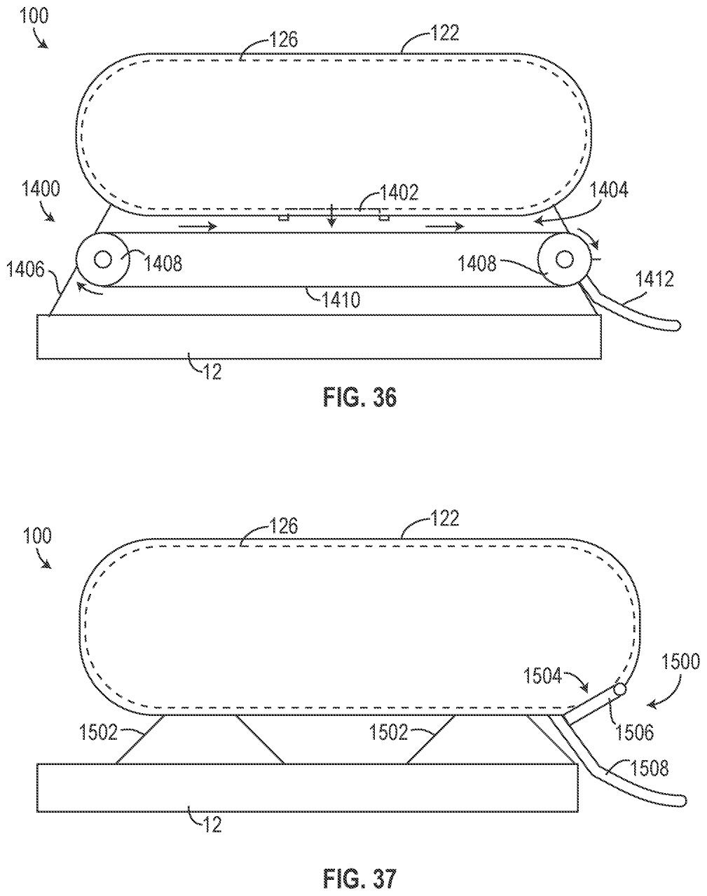

Referring to FIG. 36, the mixer drum 122 may be configured to discharge the slurry material from the inner volume 126a and/or the inner volume 126b via a conveyor discharge system 1400. In some embodiments, the mixer drum 122 is positioned on a mount 1406 that is coupled with the chassis 12. A space 1404 is defined between a bottom of the mixer drum 122 and a conveyor belt 1410. The conveyor belt 1410 may wrap around and engage rollers 1408. The rollers 1408 may be mounted on shafts that can be driven by an electric motor to drive the conveyor belt 1410 to transport slurry material from an outlet 1402 of the mixer drum 122 to a rear of the mixer vehicle 10. In some embodiments, the outlet 1402 is covered by a trap door (e.g., a hinged door, a slidable door, etc.) that can be transitioned into an open position so that the slurry material is discharged from the mixer drum 122 onto the conveyor belt 1410. In some embodiments, the outlet 1402 is positioned at a front or rear of the mixer drum 122. In some embodiments, the conveyor system 1400 also includes a chute 1412 or a guide member that is configured to receive the slurry material from an end of the conveyor belt 1410 and guide, direct, or otherwise control an angle of discharge or pouring of the slurry material. In some embodiments, the outlet 1402 is covered by a sliding or hinged door that is electrically or hydraulically actuated. In some embodiments, the mixer vehicle 10 has a unibody design which facilitates discharging through a bottom of the mixer drum 122 (e.g., via the conveyor discharge system 1400).

### Rear Trap Door Outlet

Referring to FIG. 37, the mixer drum 122 may include a trap door outlet 1500 at a rear of the mixer drum 122. In some embodiments, the mixer drum 122 is elevated or raised relative to the chassis 12 on mounts 1502. The trap door outlet 1500 includes a door 1506 that may be hingedly or slidably coupled with the mixer drum 122 and is transitionable between an open position and a closed position to either allow or limit egress of the slurry material through an opening 1504. In some embodiments, a chute 1508 is positioned proximate the door 1506 such that slurry material that is discharged may be guided or poured along the chute 1508. In some embodiments, the mixer drum 122 is angled such that gravity pulls the slurry material to slide or pour down the drum to the end of the drum 122 where the door 1506 is located. In some embodiments, the screw 102 can be operated to drive or bias the slurry material towards the door 1506. In some embodiments, the slurry material may be discharged through the trap door outlet 1500 and through a gate valve. In some embodiments, the mixer drum 122 includes multiple of the door outlets 1500 having different shapes and sizes. For example, the mixer drum 122 may include a large door and a smaller door for discharging the slurry material for a paving operation and for discharging the slurry material to a wheel barrow. In some embodiments, the twin screw mixer system 100 includes a pump truck gate and various chutes and can accommodate different discharge systems.

### Side Door Outlet

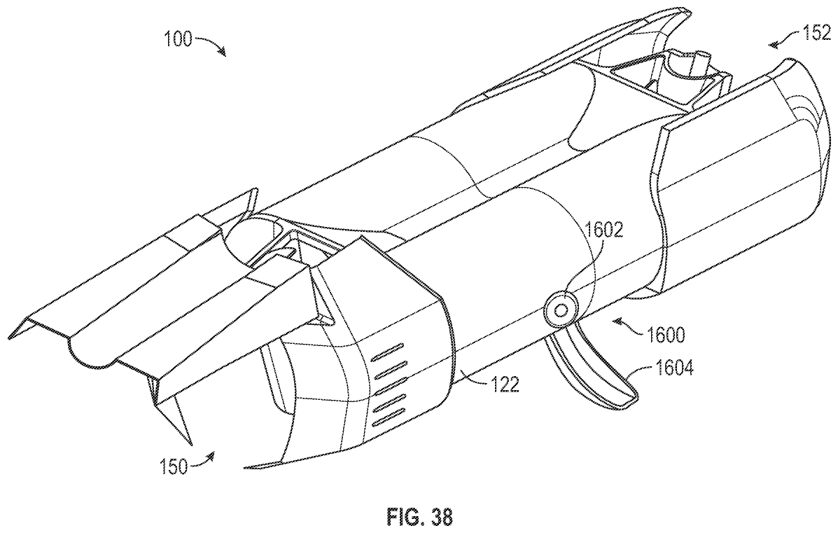

Referring to FIG. 38, the mixer drum 122 may include one or more side door outlets 1600 positioned along the mixer drum 122 (e.g., for discharging to wheel barrows, to a side discharge system, etc.). In some embodiments, the side door outlet 1600 is similar to the trap door outlet 1500 that is positioned at the rear of the mixer drum 122, but configured for side egress of the slurry material from the mixer drum 122. In some embodiments, the side door outlets 1600 include a plug or door 1602 that is removably coupled (e.g., threadingly, hingedly, interference fit, press fit, etc.) with the mixer drum 122 to cover or allow access to a corresponding opening of the mixer drum 122. When the door 1602 is transitioned into an open position, the slurry material may discharge from the mixer drum 122 due to gravitational forces and the operation of the screws 102 through the opening, and travel along a chute 1604. In some embodiments, the opening and the door 1602 are position at a middle point, a front end, or a rear end of the mixer drum 122. In some embodiments, the door 1602 is also configured to receive (e.g., threadingly couple with) a hose of the mixer vehicle 10 for discharge of the slurry material through the hose. For example, the mixer vehicle 10 may be equipped with a pump, hose, and boom section (e.g., a vacuum style truck) for discharging and pouring the slurry material. In some embodiments, the door 1602 is a port for a pump truck to draw a suction and drive egress of the slurry material from the mixer drum 122, thereby eliminating a need for the front discharge system 200 and the rear discharge system 300.

### Externally Mounted Nozzles

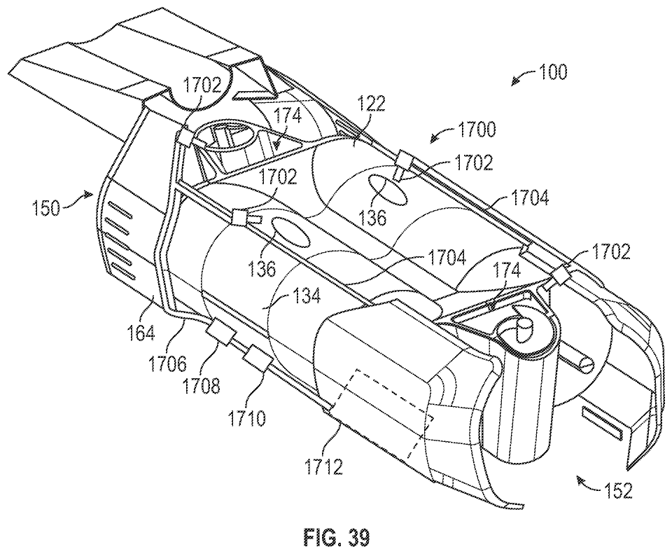

Referring to FIG. 39, the twin screw mixer system 100 can include a nozzle system 1700 (e.g., a washout system, an additive system, etc.) including one or more nozzles 1702 that are mounted externally to the mixer drum 122 and configured to discharge or spray a fluid into the mixer drum 122. In some embodiments, the nozzles 1702 are fluidly coupled through a piping or hose system 1706. The hose system 1706 may be fluidly coupled with a nozzle 1708 and a pump 1710. In some embodiments, the pump 1710 is fluidly coupled with a fluid reservoir 1712 that includes a fluidic additive or a washout fluid. In some embodiments, the nozzles 1702 are positioned proximate openings of the channels 174 so that the nozzles 1702 can discharge fluid into the first inner volume 126a and the second inner volume 126b. In some embodiments, one or more of the nozzles 1702 are positioned proximate an opening 136 that can be selectively opened or closed (e.g., a door) to facilitate access to the inner volumes of the mixer drum 122. In some embodiments, the mixer drum 122 is formed by the assembly of multiple sections that are coupled with each other, and the sections may be removed so that the nozzles 1702 can discharge fluid (e.g., washout fluid) onto the screws 102. In some embodiments, a panel 134 of the mixer drum is removable such that the nozzles 1702 can spray fluid onto the screws 102. In some embodiments, the screws 102 may be operated by a drive system (e.g., by either of the chain drive systems described in greater detail above with reference to FIGS. 28-29, by operation of the mixer driver 502a and 502b, etc.) to rotate at a maximum or high speed (e.g., greater than a speed used for mixing and/or discharge) such that any slurry material present on or sticking to the screws 102 is removed due to centripetal force. The opening 136 and/or the doors 1102 as described in greater detail above can also provide access points for service operations of twin screw mixer system 100.

### Reservoirs Above Drum

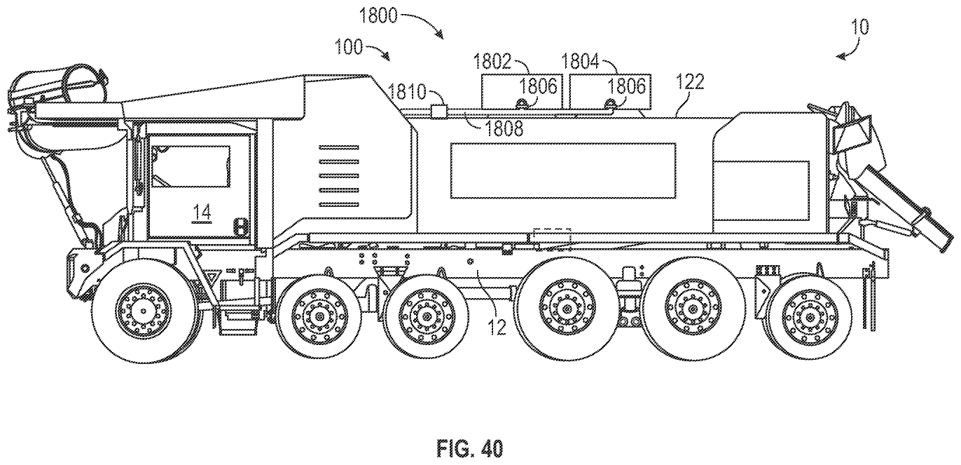

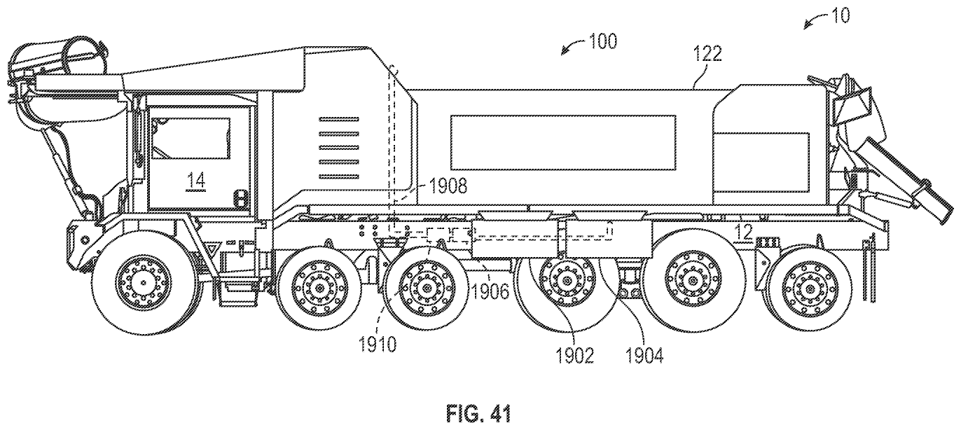

Referring to FIG. 40, the mixer vehicle 10 includes a reservoir system 1800 that may be configured to provide washout fluid, mixing fluid, or additives to the mixer drum 122. In some embodiments, the reservoir system 1800 is a roof-mounted system including a fluid reservoir 1802 (e.g., a reservoir of washout fluid) and an additive reservoir 1804. The fluid reservoir 1802 and the additive reservoir 1804 can be positioned on top of the mixer drum 122 (e.g., above the mixer drum 122 on mounts) and are fluidly coupled with a tubular member 1808. In some embodiments, the tubular member 1808 is configured to fluidly couple with and provide fluid from either of the fluid reservoir 1802 and the additive reservoir 1804 to a pump 1810 that pressurizes the fluid. In some embodiments, the pump 1810 is configured to provide the washout fluid or the additive to the nozzle system 1700. In some embodiments, the fluid reservoir 1802 and the additive reservoir 1804 both include a valve 1806 that can be transitioned between an open position and a closed position to provide fluid to the tubular member 1808. In some embodiments, the fluid reservoir 1802 and the additive reservoir 1804 do not require a pump and use gravity to discharge fluid into the mixer drum 122.

### Reservoirs Below Drum

Referring to FIG. 41, the mixer vehicle 10 may include a reservoir system 1900 that may be configured to provide washout fluid, mixing fluid, or additives to the mixer drum 122. In some embodiments, the reservoir system 1900 is similar to the reservoir system 1800 but is a below-drum configuration including a fluid reservoir 1902 (e.g., a reservoir of washout fluid) and an additive reservoir 1904. The fluid reservoir 1902 and the additive reservoir 1904 may be positioned beneath or at least partially below the mixer drum 122. In some embodiments, the fluid reservoir 1902 and the additive reservoir 1904 are coupled with an underside of the mixer drum 122. In some embodiments, the fluid reservoir 1902 and the additive reservoir 1904 are coupled with the chassis 12 (e.g., between frame rails, laterally outwards or along a lateral outwards side of the frame rails of the chassis 12, etc.). In some embodiments, the fluid reservoir 1902 and the additive reservoir 1904 are fluidly coupled with a nozzle or a discharge device (e.g., the nozzle system 1700) through a tubular member 1908 (e.g., a piping system) that includes a pump 1910 (e.g., a pressurization device such as a pneumatic pump, an electric pump, a hydraulic pump, etc.). In some embodiments, the reservoir system 1900 includes a manifold 1906 configured to fluidly couple with both the fluid reservoir 1902 and the additive reservoir 1904 and selectively fluidly couple one of the fluid reservoir 1902 and the additive reservoir 1904 with the pump 1910 for discharge.

### Angled Mixer Drum

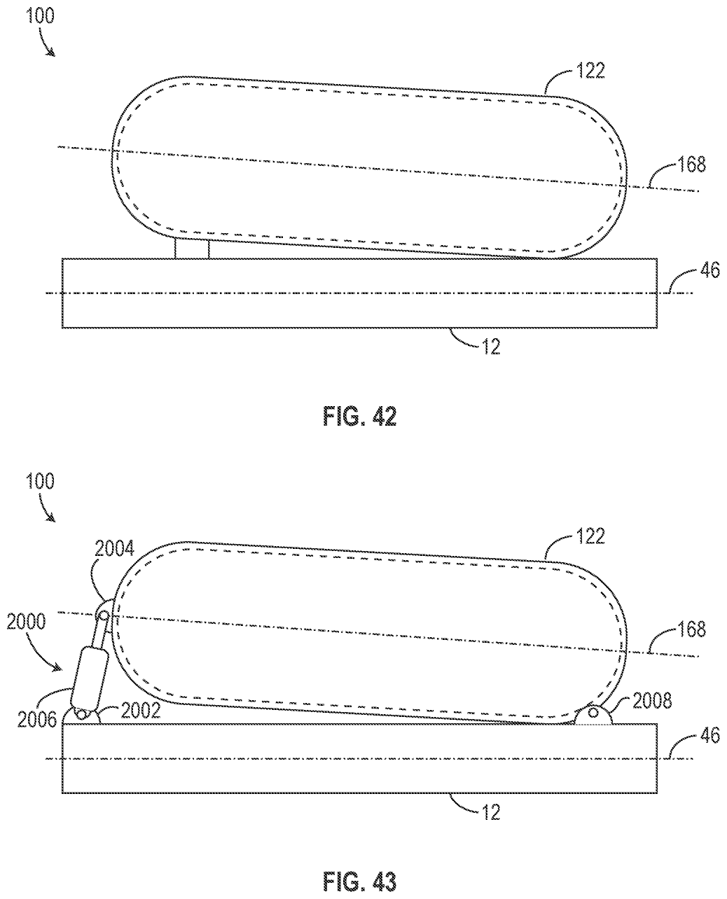

Referring to FIGS. 42-43, the mixer drum 122 may be oriented at an angle relative to the chassis 12 such that the slurry material within the mixer drum 122 is bias (e.g., by gravity) to travel towards a rear of the mixer drum 122. In some embodiments, the longitudinal axis 168 of the twin screw mixer system 100 is angled relative to the longitudinal axis 46 of the mixer vehicle 10 (e.g., the chassis 12). In some embodiments, the mixer drum 122 is mounted or fixed at the angle shown in FIG. 42. In some embodiments, the angle of the mixer drum 122 is adjustable by a lift system 2000 that includes an actuator 2006 (e.g., a hydraulic actuator, a pneumatic actuator, a linear electric actuator, etc.) that is pivotally coupled with the frame 12 at pivotal coupling 2002 and an end of the mixer drum 122 at pivotal coupling 2004. In some embodiments, the mixer drum 122 is hingedly coupled with the chassis 12 at hinge 2008. The actuator 2006 may extend or retract to drive the mixer drum 122 to rotate about the hinge 2008 to adjust the angle of the mixer drum 122 relative to the chassis 12 (e.g., to bias the slurry material to travel to the back of the mixer drum 122 during a rear discharge). In some embodiments, the twin screw mixer system 100 includes a pair of the mixer drums 122 (e.g., separate drums) that are rotatably mounted with the chassis 12 at an angle, similar to the configuration shown in FIG. 42. The mixer drums 122 may be driven (e.g., by the driveline 1300) to rotate to mix the slurry material. In some embodiments, a pair of screws (e.g., fixed screws) are positioned within the mixer drums 122, so that as the mixer drums 122 are driven to rotate about axes 168, the slurry material is mixed by the screws 102.

Screw with Removable Fins

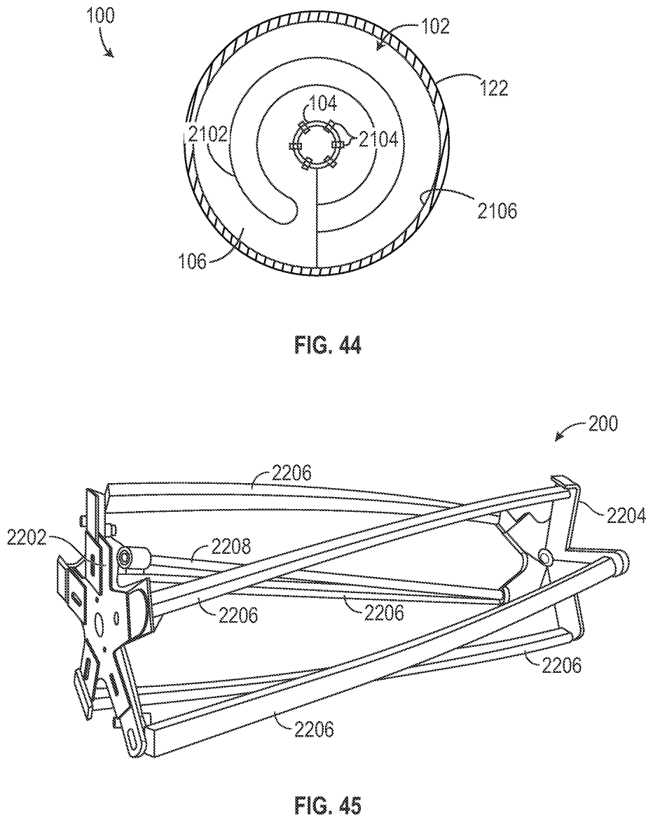

Referring to FIG. 44, the screw 102 can be configured to directly engage or contact the interior surface of the mixer drum 122 along engagement 2106. In some embodiments, the screw 102 is configured to dead head the slurry material against the sides of the mixer drum 122 and includes openings 2102 along the helical surfaces 106 such that the slurry material can flow through the openings 2102. In some embodiments, the screws 102 are provided as a hub and spoke design such that slurry material can transfer between the spokes. In some embodiments, the helical surfaces 106 are removably coupled with the shaft 104 through fasteners 2104. In this way, the helical surfaces 106 may be removed, replaced, serviced, upgraded, etc. In some embodiments, the helical surfaces 106 are manufactured from a polymeric material and may seal and wear along the engagement 2106. In some embodiments, one or more sections of fins (e.g., the helical surfaces 106) are removably coupled with the shaft 104 through fasteners 2104 such that the different sections of the helical surfaces 106 can be removed, replaced, upgraded, repaired, etc.

### Torsionally Loaded Mixer

Referring to FIG. 45, the screw 102 may be provided as a torsionally loaded reel 2200 including a first member 2202, a second member 2204, multiple elongated members 2206 extending between the first member 2202 and the second member 2204, and a loaded member 2208. In some embodiments, the first member 2202 and the second member 2204 have different sizes (e.g., the second member 2204 is smaller than the first member 2202). In some embodiments, the elongated members 2206 are deflected due to relative angulation of the second member 2204 relative to the first member 2202. In some embodiments, the loaded member 2208 is configured to counter a torque exerted between the first member 2202 and the second member 2204 due to the deflection of the elongated members 2206. The torsionally loaded reel 2200 may be provided on a driveshaft and positioned within the mixer drum 122 to mix the slurry materials.

### Rotatable Drum

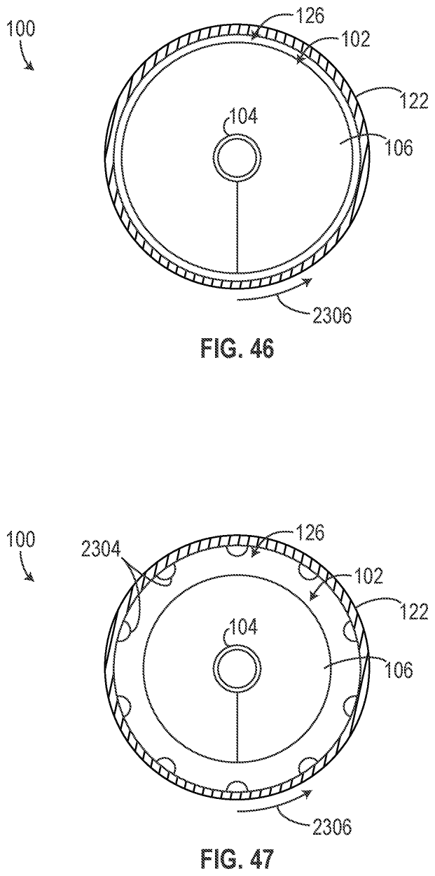

Referring to FIGS. 46-47, the mixer drum 122 may be configured to rotate relative to the screw 102. In some embodiments, the mixer drum 122 is mounted on a drive shaft and is driven by an electric or hydraulic motor (or by the driveline 1300). In some embodiments, the mixer drum 122 includes one or more fins or protrusions, shown as mixing elements 2304 positioned about the inner surface of the mixer drum 122. In some embodiments, the mixer drum 122 is driven to rotate, relative to the chassis 12 or the screw 102, in a direction 2306. In some embodiments, the screw 102 is fixed stationary and the mixer drum 122 rotates relative to the screw 102. In some embodiments, the screw 102 is driven to rotate in a same direction as the mixer drum 122 but at a different speed, or in an opposite direction as the mixer drum 122. In some embodiments, the mixer drum 122 is configured to rotate and mix the slurry materials by using the mixing elements 2304 without the screw 102. In some embodiments, one or more vertically mounted fans or blades are disposed along the bottom of the mixer drum 122 and are configured to operate to mix the slurry material within the mixer drum 122.

### Screw Axis Orientations

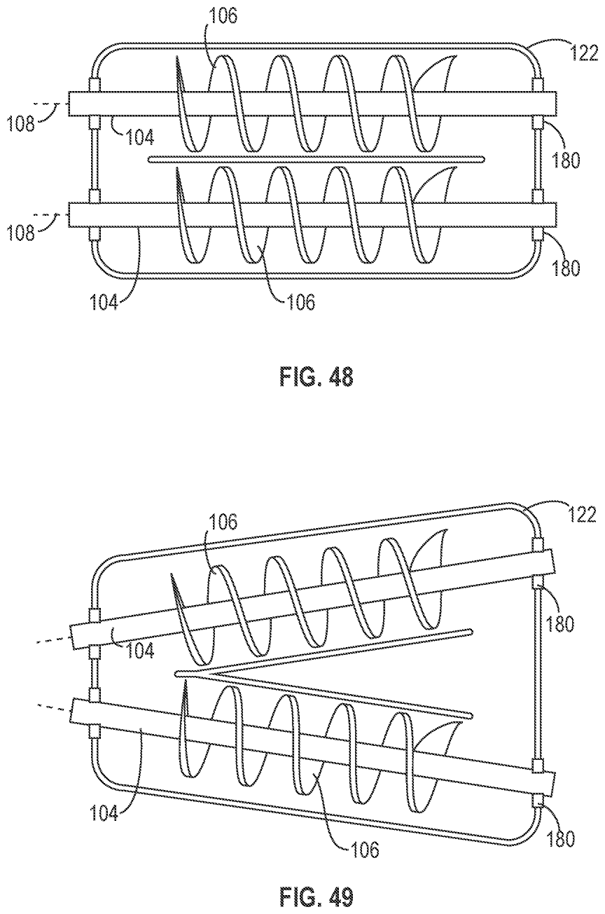

Referring to FIGS. 48-49, the screws 102 may be oriented about axes 108 which are parallel, as shown in FIG. 48, or may be oriented in a non-parallel manner, as shown in FIG. 49. In some embodiments, the screws 102 extend along axes 108 that extend towards each other. In some embodiments, the screws 102 have a uniform diameter and are non-parallel. In some embodiments, the screws 102 have a non-uniform or a tapered diameter along a length of the screws (e.g., a diameter of the helical surfaces 106). In some embodiments, the screws 102 are parallel (e.g., as shown in FIG. 48) but have a tapered shape along a length of the screws 102 (e.g., a tapered diameter of the helical surfaces 106 and the shafts 104). In some embodiments, the mixer drum 122 has a shape that tapers along a length of the mixer drum 122 (e.g., with parallel or non-parallel screws, and/or tapered or uniform screws 102).

### Service Gangway

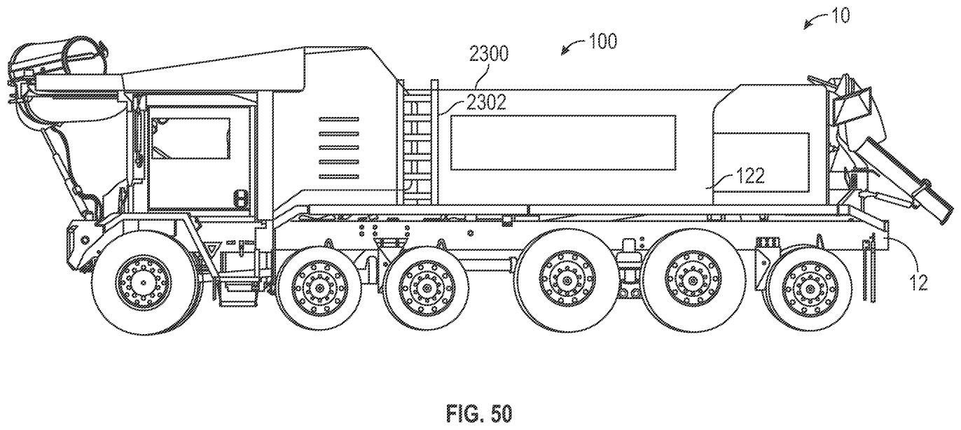

Referring to FIG. 50, the mixer vehicle 10 may include a service gangway 2300 positioned above the mixer drum 122. In some embodiments, the service gangway 2300 is accessible via a ladder 2302 that is positioned along side the mixer drum 122 (e.g., on a lateral side of the mixer vehicle 10. Advantageously, the service gangway 2300 and the ladder 2302 facilitate access to service points on a top of the mixer drum 122 (e.g., the openings 1104) or for washing out the mixer drum 122.

Mixer Drum with Passageways

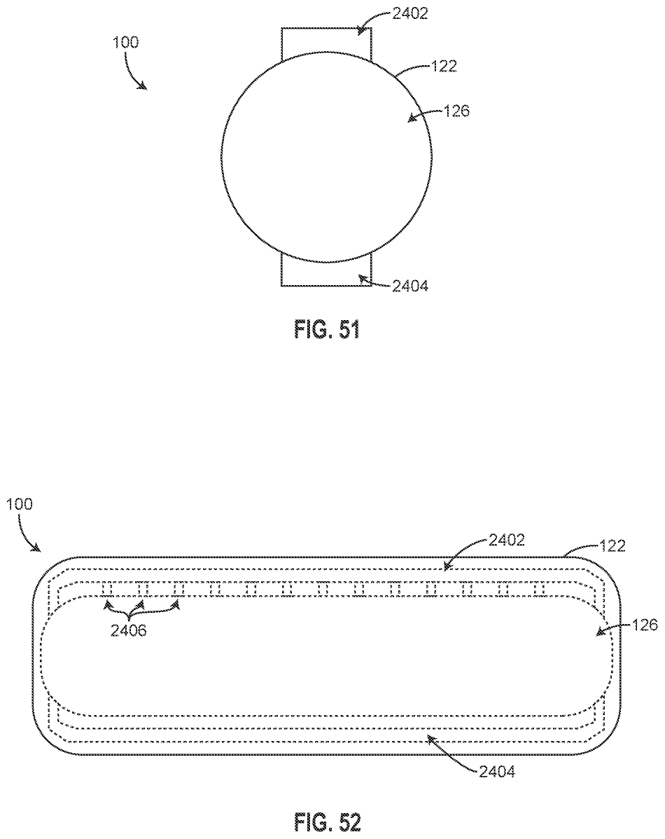

Referring to FIGS. 51-52, the mixer drum 122 may include a top passageway 2402 and/or a bottom passageway 2404 above the inner volume 126 of the mixer drum 122. In some embodiments, the inner volume 126 is the interior of a circular or cylindrical portion of the mixer drum 122, within which one of the screws 102 is positioned. In some embodiments, the top passageway 2402 extends from a front end to a rear end of the mixer drum 122 and is configured to facilitate the transfer of the slurry material between the front end and the rear end of the mixer drum 122. In some embodiments, the bottom passageway 2404 is similarly configured to facilitate the transfer of the slurry material between the front end and the rear end of the mixer drum 122. In some embodiments, the top passageway 2402 and the bottom passageway 2404 both include inlets at the front and rear end of the mixer drum 122 where the top passageway 2402 and the bottom passageway 2404 fluidly couple with the inner volume 126. In some embodiments, the top passageway 2402 includes one or more openings or passages 2406 that extend between the top passageway 2402 and the inner volume 126 to fluidly couple the top passageway 2402 with the inner volume 126 so that slurry material may fall back into the inner volume 126 as the slurry material travels along the top passageway 2402. In some embodiments, the top passageway 2402, the bottom passageway 2404, and/or the passages 2406 include sliding doors (e.g., without seals). In some embodiments, the top passageway 2402, the bottom passageway 2404, and/or the passages 2406 are configured to use air or water/chemical movement to clear slurry material out of the top passageway 2402, the bottom passageway 2404, and/or the passages 2406 (e.g., while dumping or mixing).

### Multi-Section Drum and Screws

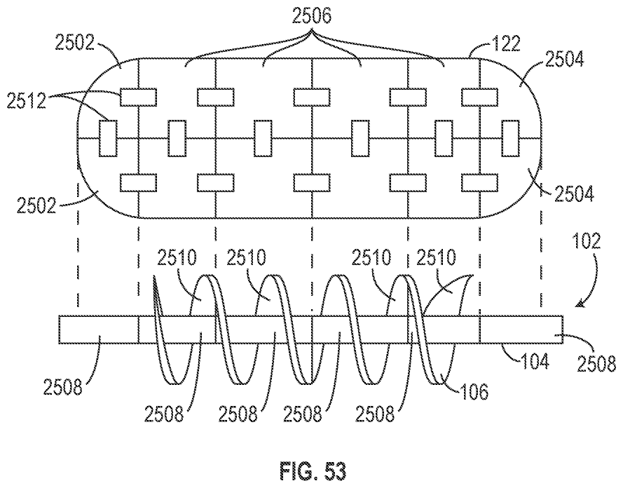

Referring to FIG. 53, the mixer drum 122 and the screws 102 may be formed or assembled from multiple discrete sections that can be individually removed (e.g., serviced, replaced, etc.). In some embodiments, the mixer drum 122 includes one or more end sections, shown as sections 2502 for a first end of the mixer drum 122, one or more end sections, shown as sections 2504 for a second end of the mixer drum 122, and one or more middle sections 2506. In some embodiments, the sections 2502, the sections 2504, and the sections 2506 include seals along a periphery or outer portion (e.g., along an edge) and are configured to seal with each other. In some embodiments, the sections 2502, the sections 2504, and the sections 2506 are configured to interlock or press fit with each other to facilitate sealing. In some embodiments, the sections 2502, the sections 2504, and the sections 2506 are planar or surface members that, when assembled, produce or define a shell (e.g., the mixer drum 122). In some embodiments, the sections 2502, the section 2504, and the sections 2506 can be coupled with each other through one or more external members 2512 (e.g., couplers, fasteners, protrusions, intermediate members, etc.). In some embodiments, the screws 102 are also formed from multiple sections (e.g., multiple sections of shaft 104 that are threadingly coupled or fastened with each other, and multiple sections of helical surfaces 106 or fins that are removably coupled with the shaft 104). In some embodiments, the screws 102 include shaft sections 2508, and mixer sections 2510. In some embodiments, the shaft sections 2508 and the mixer sections 2510 have transitions or couple at locations that longitudinally correspond to the different sections or transitions between the sections of the mixer drum 122 such that one of the sections 2502, 2504, or 2506 may be removed in order to facilitate removal of the correspondingly located shaft sections 2508 and mixer sections 2510 (e.g., to service or replace a particular portion of the screw 102 without completely disassembling the mixer drum 122 and without completely disassembling or removing the screw 102 from the mixer drum 122).

In some embodiments, each of the sections 2502, 2504, and 2506 of the mixer drum 122 include both a surface and corresponding structural members (e.g., skeleton members). In some embodiments, the structural members are configured to couple with each other when installed to thereby provide a robust skeleton for the mixer drum 122. In some embodiments, the surfaces of the sections 2502, 2504, and 2506 include a plastic, nonmetallic or composite material and the structural members are manufactured from a heavier, more robust material (e.g., steel, metal, etc.) to facilitate improved strength and reduced weight of the mixer drum 122.

### Battery Placement

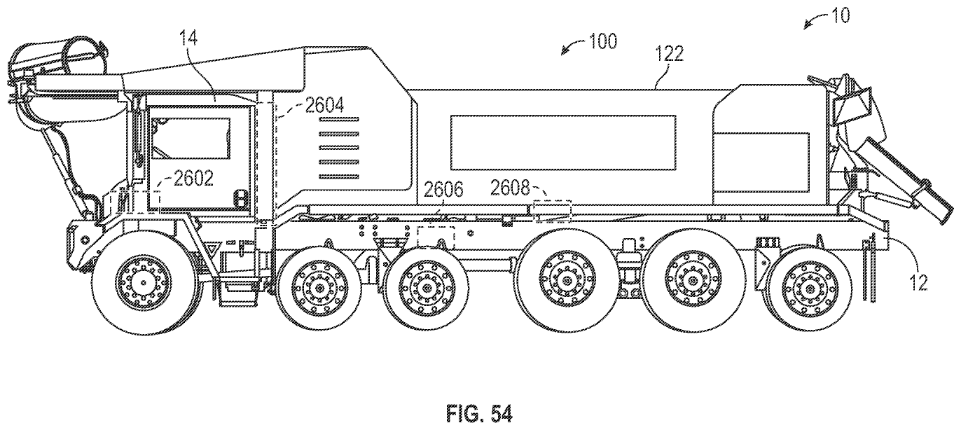

Referring to FIG. 54, the mixer vehicle 10 can include one or more batteries configured to provide electrical power for mixing the slurry material of the twin screw mixer system 100 (e.g., the mixer drivers 502). The batteries may be positioned within an engine bay, shown as batteries 2602. In some embodiments, the batteries are positioned behind the cab 14, shown as batteries 2604. In some embodiments, the batteries are positioned between frame rails of the chassis 12, shown as batteries 2606 (e.g., beneath the mixer drum 122). In some embodiments, the batteries are positioned on top of the chassis 12, shown as batteries 2608 (e.g., beneath the mixer drum 122, extending into a space of the mixer drum 122 between the two chambers, etc.).

### Discharge Chutes

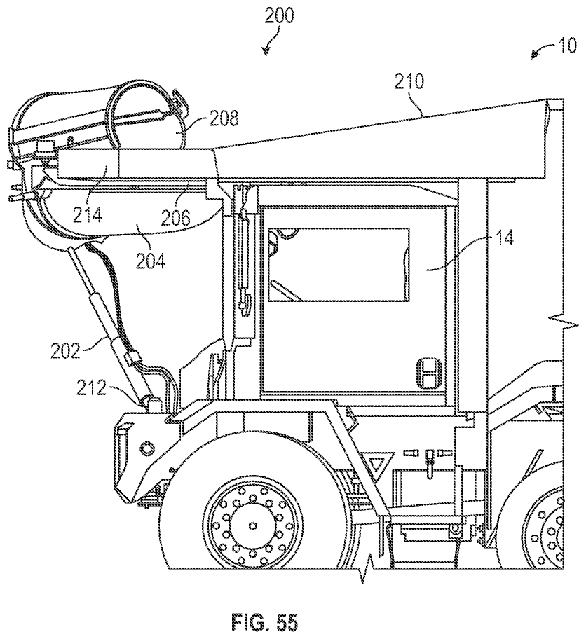

Referring to FIG. 55, the front discharge system 200 is shown in greater detail, according to some embodiments. The front discharge system 200 is configured to receive slurry material from the mixer drum 122 (e.g., due to operation of the discharge screw 112a and transfer along the channel 162. The front discharge system 200 includes a first chute 204 that is coupled with a platform 214, and a second chute 208 that is hingedly coupled with an end of the first chute 204. The second chute 208 can be rotated relative to the first chute 204 such that the first chute 204 and the second chute 208 form a single chute for discharge and pouring of the slurry material. In some embodiments, the front discharge system 200 includes a channel 210 that extends over the cab 14 and receives the slurry material from the channel 162. The channel 210 directs the slurry material to the first chute 204. In some embodiments, the front discharge system 200 includes a first actuator 206 (e.g., a hydraulic actuator, an electric actuator, a rotational actuator, etc.) configured to drive rotation of the first chute 204 and the second chute 208 about a vertical axis. In some embodiments, the front discharge system 200 also includes a second actuator 202 (e.g., a linear electric actuator, a hydraulic actuator, etc.) that is coupled at one end with the first chute 204 and at a second end with a bumper 212 of the mixer vehicle 10. In some embodiments, the second actuator 202 is configured to raise or lower the first chute 204 and the second chute 208 to thereby adjust a pouring angle of the slurry material.

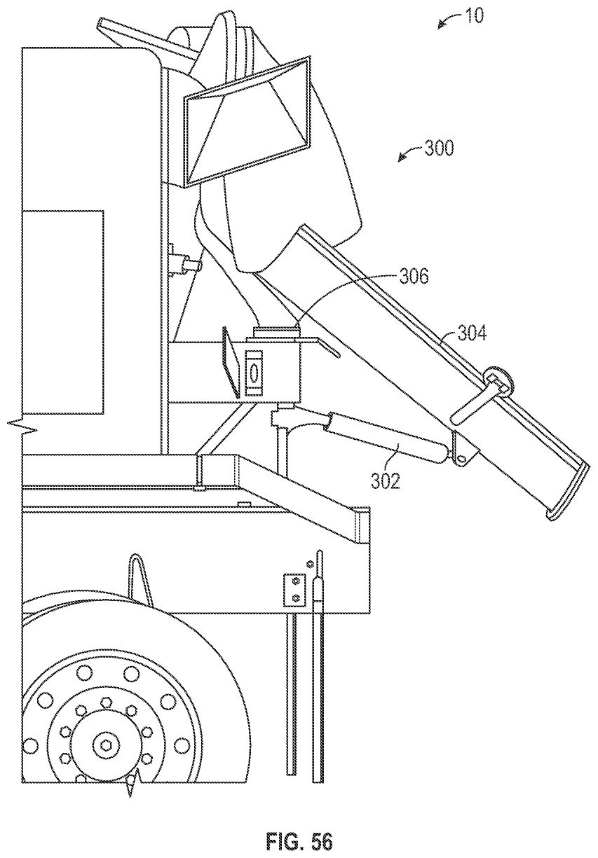

Referring to FIG. 56, the rear discharge system 300 is configured to receive the slurry material from the discharge screw 112b and direct pouring direction or angles of the slurry material. The rear discharge system 300 includes a chute 304, a first actuator 302, and a second actuator 306. In some embodiments, the chute 304 is pivotally coupled with a rear of the mixer vehicle 10 (e.g., through a swivel joint). In some embodiments, the first actuator 302 (e.g., a linear electric actuator, a hydraulic actuator, etc.) is configured to raise or lower the chute 304 to adjust an angle of the chute 304 about a first axis. In some embodiments, the second actuator 306 is configured to pivot the chute 304 about a second axis (e.g., a vertical axis) to adjust a pour direction of the slurry material. In this way, the rear discharge system 300 can be controlled to perform a desired pour of the slurry material.

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure. The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the refuse vehicle 10 and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A mixer vehicle comprising:
a chassis;
a mixer drum coupled with the chassis, the mixer drum defining a first cylindrical inner volume and a second cylindrical inner volume, wherein the first cylindrical inner volume and the second cylindrical inner volume are fluidly coupled with each other at passageways positioned at both ends of the mixer drum;
a first mixer screw positioned within the first cylindrical inner volume; and,
a second mixer screw positioned within the second cylindrical inner volume;
wherein the first mixer screw and the second mixer screw are configured to be driven to rotate to drive a slurry material between the first cylindrical inner volume and the second cylindrical inner volume to mix the slurry material.

2. The mixer vehicle of claim 1, wherein the first mixer screw and the second mixer screw each comprise a shaft and a plurality of helical surfaces or fins extending radially outwards from the shaft.

3. The mixer vehicle of claim 1, wherein the first mixer screw and the second mixer screw are configured to operate to drive the slurry material towards a rear of the mixer drum for a rear discharge of the slurry material from the mixer drum.

4. The mixer vehicle of claim 1, wherein the first mixer screw and the second mixer screw are configured to operate to drive the slurry material towards a front of the mixer drum for a front discharge of the slurry material from the mixer drum.

5. The mixer vehicle of claim 1, further comprising a discharge system, wherein the discharge system comprises a first discharge auger positioned at a first end of the mixer drum.

6. The mixer vehicle of claim 5, wherein the discharge system further includes a second discharge auger positioned at a second end of the mixer drum, the first discharge auger and the second discharge auger extending into the mixer drum and configured to discharge the slurry material from the mixer drum to a first chute assembly positioned at a forward end of the mixer vehicle or a second chute assembly positioned at a rearward end of the mixer vehicle.

7. The discharge system of claim 6, further comprising a mount coupled to the chassis and the mixer drum, the second chute assembly positioned at the rearwards end of the mixer vehicle, and a conveyor belt driven by an electric motor, wherein the slurry material is discharged via the second chute assembly onto a conveyor belt.

8. The mixer vehicle of claim 1, further comprising a side door outlet and a side door removably coupled to the mixer drum, such that the slurry material is discharged from the mixer drum through the side door outlet when the side door is removed from the mixer drum.

9. The side door outlet of claim 8, wherein the side door is configured to receive a hose or a pump such that the slurry material is discharged via the hose or the pump without the side door being removed from the mixer drum.

10. The mixer vehicle of claim 1, wherein the mixer drum is configured to rotate relative to the first mixer screw and the second mixer screw.

11. The mixer vehicle of claim 1, wherein the first mixer screw and the second mixer screw comprise a first torsionally loaded mixer reel and a second torsionally loaded mixer reel, wherein the first torsionally loaded mixer reel and the second torsionally loaded mixer reel each comprise a first member and a second member, at least one elongated member extending between the first member and the second member, and at least one loaded member extending between the first member and the second member.

12. A mixer system for a mixer vehicle, the mixer system comprising:
a first mixer screw;
a second mixer screw, wherein the first mixer screw and the second mixer screw each comprise a shaft and a plurality of helical surfaces or fins extending radially outwards from the shaft; and
a mixer driver coupled to the first mixer screw and the second mixer screw, the mixer driver being configured to rotate the first mixer screw and the second mixer screw to mix a slurry material.

13. The mixer system of claim 12, further comprising a controller in communication with the mixer driver, the controller being configured to:
measure a consistency of the slurry material based on a pressure or an amperage draw of the mixer driver;
determine a desired consistency of the slurry material; and
adjust a speed of rotation of the first mixer screw and the second mixer screw to obtain the desired consistency of the slurry material.

14. The mixer system of claim 13, wherein the controller is configured to:
measure the amperage draw of the mixer driver;
determine a slump of the mixer driver based on the amperage draw of the mixer driver;
adjust operation of the mixer driver based on the slump; and
present a notification of an additive being introduced into the mixer drum.

15. The mixer system of claim 13, wherein the controller is configured to:
measure the pressure of the mixer driver;
determine a slump of the mixer driver based on the pressure of the mixer driver;
adjust operation of the mixer driver based on the slump; and
present a notification of an additive being introduced into the mixer drum.

16. The mixer system of claim 12, further comprising one or more batteries configured to provide electrical power to the mixer driver.

17. A method of manufacturing a mixer vehicle, comprising:
providing a chassis including a frame member extending substantially horizontally and having a front end and a rear end;
coupling a mixer drum to the chassis, wherein the mixer drum defines a first cylindrical inner volume and a second cylindrical inner volume,
positioning a first mixer screw within the first cylindrical inner volume;
positioning a second mixer screw within the second cylindrical inner volume; and
driving the first mixer screw and the second mixer screw to rotate and mix a slurry material between the first cylindrical inner volume and the second cylindrical inner volume.

18. The method of claim 17, further comprising:
measuring a consistency of the slurry material;
operating the first mixer screw and the second mixer screw to adjust the consistency of the slurry material.

19. The method of claim 17, further comprising powering the first mixer screw and the second mixer screw using a battery.

20. The method of claim 17 further comprising:
positioning a first discharge auger at a first end of the mixer drum,
positioning a second discharge auger at a second end of the mixer drum; and
discharging, via the first discharge auger and the second discharge auger, the slurry material from the mixer drum.
